(19) United States
(12) Patent Application Publication
(10) Pub. No.: US 2014/0060796 A1
(43) Pub. Date: Mar. 6, 2014

(54) AIR CONDITIONER FOR VEHICLE

(71) Applicants: Yoshinori Ichishi, Kariya-city (JP); Yoshinori Yanagimachi, Takahama-city (JP); Yasushi Kondo, Aichi-gun (JP); Ryuji Hayashi, Miyoshi-city (JP); Yoshihisa Shimada, Nagoya-city (JP); Hidekazu Hirabayashi, Chiryu-city (JP)

(72) Inventors: Yoshinori Ichishi, Kariya-city (JP); Yoshinori Yanagimachi, Takahama-city (JP); Yasushi Kondo, Aichi-gun (JP); Ryuji Hayashi, Miyoshi-city (JP); Yoshihisa Shimada, Nagoya-city (JP); Hidekazu Hirabayashi, Chiryu-city (JP)

(73) Assignee: TOYOTA JIDOSHA KABUSHIKI KAISHA, Toyota-shi, Aichi-ken (JP)

(21) Appl. No.: 14/116,239

(22) PCT Filed: Jul. 3, 2012
(86) PCT No.: PCT/JP2012/066979

§ 371 Date: Nov. 7, 2013

(30) Foreign Application Priority Data
Aug. 30, 2011 (JP) 2011-187318

(51) Int. Cl. B60H 1/00

(52) U.S. Cl. CPC B60H 1/0075; B60H 1/00892; B60H 1/00064
USPC 165/204; 165/41

(57) ABSTRACT

An air conditioner for a vehicle includes a blower; a heat exchanger that heats the blown air by heat exchanger between blown air and a heat medium, a control device, and an air outlet mode switching device that switches between air outlet modes by switching proportions of air flow blown out from outlets which includes a face air outlet and a foot air outlet, wherein the control device limits the availability factor of the blower based on a temperature of the heat medium; and relaxes limitation on the availability factor of the blower when the air outlet mode is a bi-level mode in which the blown air is blown out from both of the face air outlet and the foot air outlet.

### TECHNICAL FIELD

The present invention relates to an air conditioner for a vehicle.

### BACKGROUND ART

In a conventional air conditioner for a vehicle, control is exercised to stop a blower when an engine cooling water temperature is not higher than a predetermined temperature, start the blower when the engine cooling water temperature becomes higher than the predetermined temperature, and increase the amount of air blown from the blower when the engine cooling water temperature rises (refer, for instance, to PTL 1). This inhibits an occupant of the vehicle from feeling unwarmed as the blower blows insufficiently heated air to the feet of the occupant if the engine cooling water temperature is low when, for instance, a heater is started.

### CITATION LIST

### Patent Literature

### [PTL 1]

Japanese Patent Application Publication No. 2769073

### SUMMARY OF INVENTION

### Technical Problem

However, when the invention described in PTL 1 is employed, the temperature of the engine cooling water (a heat medium for heating the blown air) needs to be raised in order to increase the rate of air flow. Therefore, if the temperature of the engine cooling water is low, the occupant feels hot at the upper body (especially, the face) and looses comfortable feeling under strong solar radiation because the rate of air flow from a face air outlet is very small in a bi-level mode.

In light of the foregoing, it is an object of the present invention to provide an air conditioner for a vehicle that is capable of improving comfort of an occupant when solar radiation is strong.

### Solution to Problem

In order to achieve the object, a first aspect of the present invention includes a blower that generates blown air; a heating heat exchanger that heats the blown air by heat exchange between the blown air and a heat medium; a control device that determines the availability factor of the blower; and an air outlet mode switching device that switches between a plurality of air outlet modes by switching proportions of air flow blown out from a plurality of outlets which includes a face air outlet that blows out the blown air to an upper body of an occupant and a foot air outlet that blows out the blown air to a lower body of an occupant, wherein the control device: limits the availability factor of the blower based on a temperature of the heat medium; and relaxes limitation on the availability factor of the blower when the air outlet mode is a bi-level mode in which the blown air is blown out from both of the face air outlet and the foot air outlet.

With this aspect, limitation on the availability factor of the blower is relaxed. Therefore, it is possible to increase the amount of the air flow blown out from the face air outlet even if the temperature of the heat medium is not sufficiently high. As a result, it is possible to improve comfort of the occupant when solar radiation is strong.

In a second aspect of the present invention according to the first aspect, the control device: determines the availability factor of the blower based on an air-conditioning load; determines an upper limit of the availability factor based on the temperature of the heat medium; limits the availability factor of the blower so that the availability factor of the blower is equal to or smaller than the upper limit when the air outlet mode is a mode in which the blown air is blown out at least from the foot air outlet; and determines the upper limit to be equal to or larger than the availability factor of the blower that is determined based on the air-conditioning load when the air outlet mode is the bi-level mode.

This makes it possible, while in the bi-level mode, to cancel the effect of the limitation on the availability factor of the blower that is caused by the temperature of the heat medium. Therefore, it is possible to surely increase the amount of the air flow blown out from the face air outlet.

In a third aspect of the present invention according to the first or second aspect, the control device does not relax the limitation on the availability factor of the blower when the engine cooling water temperature is smaller than a certain temperature even if the air outlet mode is the bi-level mode.

With this operation, it is possible to prevent the amount of the air flow blown out from the foot air outlet from increasing when the engine cooling water temperature is smaller than a certain temperature. Therefore, it is possible to ease the occupant's feeling that his/her feet are receiving cold wind when the blown air temperature is very low.

A fourth aspect of the present invention according to the third aspect, comprises an auxiliary heating means (37) that heats the blown air, wherein the control means (50) sets the certain temperature so that the certain temperature is smaller when the auxiliary heating means is operating than when the auxiliary heating means is not operating.

With this operation, it is possible to relax the limitation on the availability factor of the blower (32) when the auxiliary heating means (37) is operating even if the temperature of the heat medium is low. In addition, when the auxiliary heating means (37) is operating, it is possible to increase the blown air temperature even if the temperature of the heat medium is low. Therefore, the occupant's feeling that his/her feet are receiving cold wind is eased. As a result, it is possible to improve, when solar radiation is strong, comfort of the occupant without harming the occupant's feeling that he/she is in a warmed room.

In a fifth aspect of the present invention according to any one of the first to fourth aspects, the control means (50): limits the availability factor of the blower (32) based on the temperature of the heat medium when the air outlet mode is the bi-level mode; when the air outlet mode is a face mode in which the blown air is blown out from the face air outlet (39a), reduces limitation on the availability factor of the blower (32) compared to when in the bi-level mode; and controls the air outlet mode so that, in accordance with increase of an amount of insolation, it becomes more unlikely that the air outlet mode is determined to be the bi-level mode, and it becomes more likely that the air outlet mode is determined to be the face mode.

In a sixth aspect of the present invention includes a blower (32) that generates blown air; a heating heat exchanger (36) that heats the blown air by heat exchange between the blown air and a heat medium; an air outlet mode switching means (39d, 39e, 39f) that switches between a plurality of air outlet modes by switching proportions of air flow blown out from a plurality of outlets (39a, 39b, 39c) which includes a face air outlet (39a) that blows out the blown air to an upper body of an occupant and a foot air outlet (39b) that blows out the blown air to a lower body of an occupant, and a control means (50) that determines the availability factor of the blower (32) and the air outlet mode, wherein the control means (50): limits the availability factor of the blower (32) based on a temperature of the heat medium when the air outlet mode is a bi-level mode in which the blown air is blown out from both of the face air outlet (39a) and the foot air outlet (39b); when the air outlet mode is a face mode in which the blown air is blown out from the face air outlet (39a), reduces limitation on the availability factor of the blower (32) compared to when in the bi-level mode; and controls the air outlet mode so that, in accordance with increase of an amount of insolation, it becomes more unlikely that the air outlet mode is determined to be the bi-level mode, and it becomes more likely that the air outlet mode is determined to be the face mode.

With this operation, the larger the amount of the insolation becomes, the more unlikely it becomes that the air outlet mode is determined to be the bi-level mode, and the more likely it becomes that the air outlet mode is determined to be the face mode. Therefore, it is possible to improve comfort of the occupant by increasing the amount of the air flow blown out from the face air outlet (39a) when solar radiation is strong.

In addition, since the proportion of the amount of the air flow blown out from the foot air outlet (39b) is smaller in the face mode than in the bi-level mode, it is possible to ease the occupant's feeling that his/her feet is receiving cold wind if it becomes more likely that the air outlet mode is determined to be the face mode.

In a seventh aspect of the present invention according to the sixth aspect, the control means (50): determines the availability factor of the blower (32) based on an air-conditioning load; and in accordance with increase of the amount of the insolation, narrows down a range of the air-conditioning load in which the air outlet mode is determined to be the bi-level mode is narrowed, and widens a range of the air-conditioning load in which the air outlet mode is determined to be the face mode.

With this operation, the larger the amount of the insolation becomes, the more unlikely it becomes that the air outlet mode is determined to be the bi-level mode, and the more likely it becomes that the air outlet mode is determined to be the face mode.

Parenthesized reference signs of the means described here and under CLAIMS correlate to those of specific means described later under “Description of Embodiments.”

### BRIEF DESCRIPTION OF DRAWINGS

FIG. 1 is a diagram illustrating the overall configuration of a refrigerant circuit for a cooling mode of an air conditioner for a vehicle according to a first embodiment of the present invention.

FIG. 2 is a diagram illustrating the overall configuration of a refrigerant circuit for a heating mode of the air conditioner for a vehicle according to the first embodiment.

FIG. 3 is a diagram illustrating the overall configuration of a refrigerant circuit for a first dehumidification mode of the air conditioner for a vehicle according to the first embodiment.

FIG. 4 is a diagram illustrating the overall configuration of a refrigerant circuit for a second dehumidification mode of the air conditioner for a vehicle according to the first embodiment.

FIG. 5 is a block diagram illustrating an electrical control section of the air conditioner for a vehicle according to the first embodiment.

FIG. 6 is a circuit diagram illustrating a PTC heater according to the first embodiment.

FIG. 7 is a flowchart illustrating a control process performed by the air conditioner for a vehicle according to the first embodiment.

FIG. 8 is a flowchart illustrating an essential portion of the control process performed by the air conditioner for a vehicle according to the first embodiment.

FIG. 9 is a flowchart illustrating another essential portion of the control process performed by the air conditioner for a vehicle according to the first embodiment.

FIG. 10 is a flowchart illustrating another essential portion of the control process performed by the air conditioner for a vehicle according to the first embodiment.

FIG. 11 is a table illustrating the operating states of solenoid valves in various operation modes according to the first embodiment.

FIG. 12 is a diagram illustrating the overall configuration of the air conditioner for a vehicle according to a second embodiment of the present invention.

### DESCRIPTION OF EMBODIMENTS

Embodiments of the present invention will now be described with reference to the accompanying drawings. In the drawings depicting the embodiments, portions identical or equivalent to each other are designated by the same reference signs.

### First Embodiment

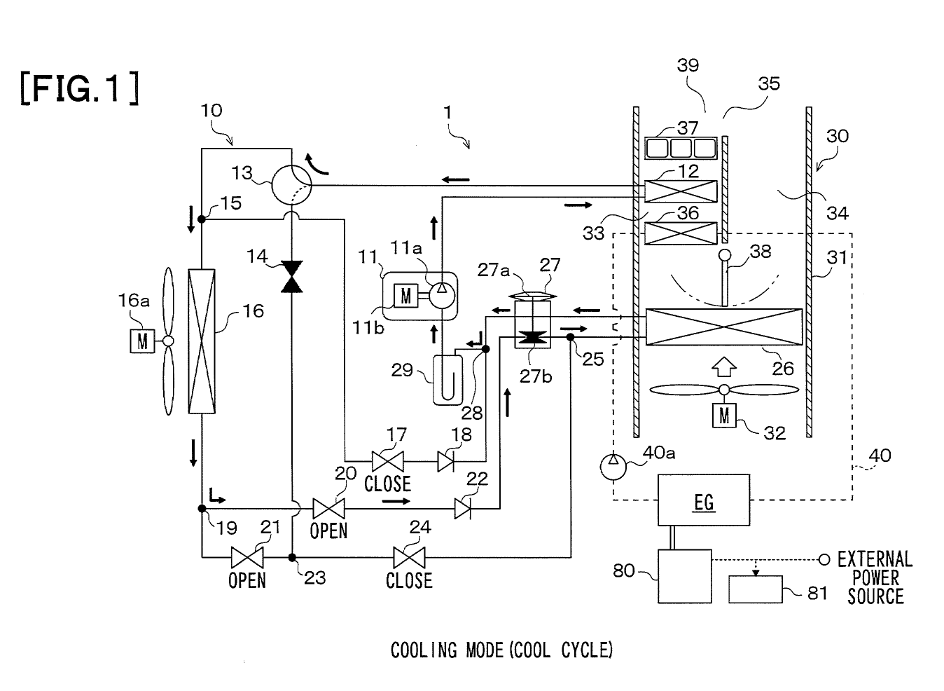

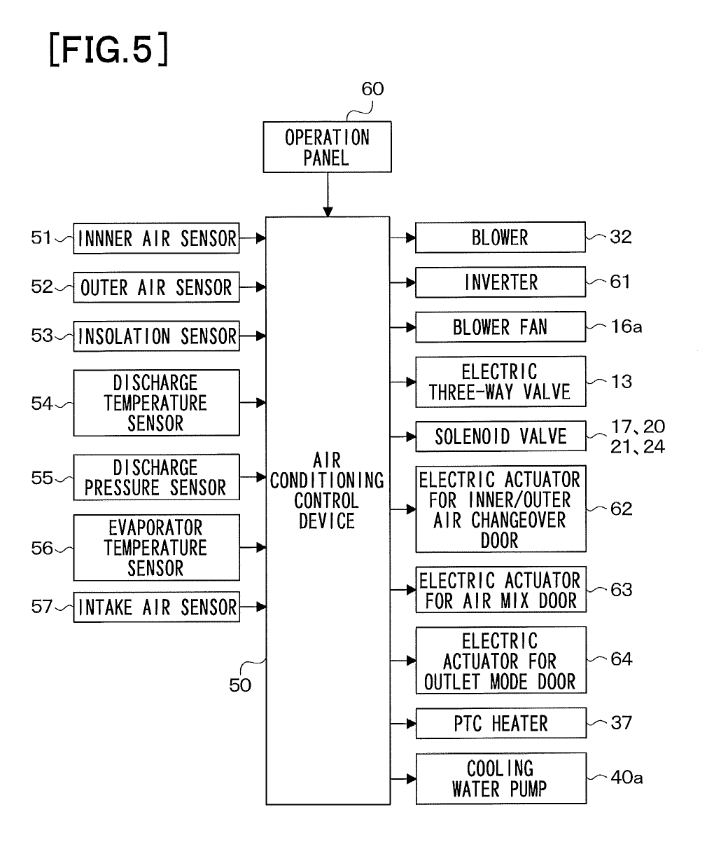

A first embodiment of the present invention will now be described with reference to FIGS. 1 to 11. FIGS. 1 to 4 are diagrams illustrating the overall configuration of an air conditioner for a vehicle according to the first embodiment. FIG. 5 is a block diagram illustrating an electrical control section of the air conditioner for a vehicle 1. In the present embodiment, the air conditioner for a vehicle is applied to a hybrid vehicle that acquires a driving force for running the vehicle from an internal combustion engine EG and from a driving electric motor.

The hybrid vehicle according to the present embodiment is a so-called plug-in hybrid vehicle capable of charging its battery 81 with electricity supplied from an external power source (commercial power source) while the vehicle is stopped. If the battery 81 is charged by the external power source while the vehicle is stopped before running so that the amount of electrical power remaining in the battery 81 is not smaller than a predetermined driving reference amount as at the beginning of running, the plug-in hybrid vehicle runs by mainly using the driving force generated by the driving electric motor (this driving mode is referred to as the EV driving mode).

If, on the other hand, the amount of electrical power remaining in the battery 81 is smaller than the predetermined driving reference amount while the vehicle is running, the plug-in hybrid vehicle runs by mainly using the driving force generated by the engine EG (this driving mode is referred to as the HV driving mode). The plug-in hybrid vehicle switches between the EV driving mode and the HV driving mode as described above to achieve improved fuel economy, or more specifically, cause the engine EG to consume a smaller amount of fuel than a normal vehicle that acquires the driving force for running the vehicle from the engine EG alone.

The EV driving mode is a driving mode in which the vehicle runs by mainly using the driving force output from the driving electric motor. However, if a vehicle driving load is high in the EV driving mode, the engine EG is operated to assist the driving electric motor. Meanwhile, the HV driving mode is a driving mode in which the vehicle runs by mainly using the driving force output from the engine EG. Similarly, however, if the vehicle driving load is high in the HV driving mode, the driving electric motor is operated to assist the engine EG. The above operations of the engine EG and of the driving electric motor are controlled by an engine control device (not shown).

Further, the driving force output from the engine EG is used not only for running the vehicle but also for operating a generator 80. Electrical power generated by the generator 80 and electrical power supplied from the external power source can be stored in the battery 81. The electrical power stored in the battery 81 can be supplied not only to the driving electric motor but also to various vehicle-mounted devices such as components of the air conditioner for a vehicle 1.

The configuration of the air conditioner for a vehicle 1 according to the present embodiment will now be described in detail. The air conditioner for a vehicle 1 is capable of not only providing normal air conditioning in a passenger compartment of the vehicle during the vehicle run, but also providing pre-air conditioning in order to provide air conditioning in the passenger compartment while the battery 81 is being charged by the external power source before an occupant enters the vehicle.

The air conditioner for a vehicle 1 has a vapor compression type refrigeration cycle 10 that selectively uses, during normal air conditioning and pre-air conditioning, a refrigerant circuit for a cooling mode (COOL cycle) for cooling the passenger compartment, a refrigerant circuit for a heating mode (HOT cycle) for heating the passenger compartment, a refrigerant circuit for a first dehumidification mode (DRY_EVA cycle) for dehumidifying the passenger compartment, and a refrigerant circuit for a second dehumidification mode (DRY_ALL cycle) for dehumidifying the passenger compartment.

FIGS. 1 to 4 use solid arrows to indicate the flow of a refrigerant in the cooling mode, the heating mode, the first dehumidification mode, or the second dehumidification mode. The first dehumidification mode is a dehumidification mode in which a dehumidification capacity takes precedence over a heating capacity, whereas the second dehumidification mode is a dehumidification mode in which the heating capacity takes precedence over the dehumidification capacity. Hence, the first dehumidification mode may be referred to as a low-temperature dehumidification mode or a simple dehumidification mode, whereas the second dehumidification mode may be referred to as a high-temperature dehumidification mode or a dehumidification-heating mode.

The refrigeration cycle 10 includes, for example, a compressor 11, an indoor condenser 12, an indoor evaporator 26, a thermostatic expansion valve 27, a fixed throttle 14, and a plurality of solenoid valves 13, 17, 20, 21, 24 (five solenoid valves in the present embodiment). The indoor condenser 12 and the indoor evaporator 26 act as an indoor heat exchanger. The thermostatic expansion valve 27 and the fixed throttle 14 act as a pressure reduction means for decompressing and expanding the refrigerant. The solenoid valves 13, 17, 20, 21, 24 act as a refrigerant circuit selection means. The refrigeration cycle 10 functions as a temperature regulation means for regulating the temperature of air blown into the passenger compartment.

Further, the refrigeration cycle 10 uses a normal Freon refrigerant and constitutes a subcritical refrigeration cycle in which the high pressure side of the refrigerant pressure does not exceed its critical pressure. Moreover, a refrigerant oil for lubricating the compressor 11 is mixed with the refrigerant. Part of the refrigerant oil circulates through the cycle together with the refrigerant.

The compressor 11 is disposed in an engine room. In the refrigeration cycle 10, the compressor 11 sucks, compresses, and discharges the refrigerant. The compressor 11 is configured as an electric compressor in which an electric motor 11b drives a fixed-capacity compression mechanism 11a having a fixed discharge capacity. Specifically, a scroll-type compression mechanism, a vane-type compression mechanism, and various other compression mechanisms may be used as the fixed-capacity compression mechanism 11a.

The electric motor 11b is an AC motor whose operation (rotation speed) is controlled by an AC voltage output from an inverter 61. The inverter 61 also outputs an AC voltage having a frequency corresponding to a control signal output from a later-described air-conditioning control device 50. This rotation speed control changes the refrigerant discharge capability of the compressor 11. Therefore, the electric motor 11b constitutes a means for changing the discharge capability of the compressor 11.

The discharge side of the compressor 11 is connected to the refrigerant inlet side of the indoor condenser 12. The indoor condenser 12 is a heating heat exchanger that is disposed in a casing 31, which forms an air path in an indoor air-conditioning unit 30 of the air conditioner for a vehicle for the air blown into the passenger compartment, and heats the blown air by heat exchange between the refrigerant distributed in the indoor condenser 12 and the blown air after passing through the later-described indoor evaporator 26. The indoor air-conditioning unit 30 will be described in detail later.

The refrigerant outlet side of the indoor condenser 12 is connected to an electric three-way valve 13. The electric three-way valve 13 is a refrigerant circuit selection means whose operation is controlled by a control voltage output from the air-conditioning control device 50.

More specifically, in an energized state in which electrical power is supplied, the electric three-way valve 13 switches to a refrigerant circuit that connects the refrigerant outlet side of the indoor condenser 12 to the refrigerant inlet side of the fixed throttle 14. In a de-energized state in which the supply of electrical power is shut off, the electric three-way valve 13 switches to a refrigerant circuit that connects the refrigerant outlet side of the indoor condenser 12 to one refrigerant inflow outlet of a first three-way joint 15.

The fixed throttle 14 is a decompression means for heating and dehumidification that decompresses and expands the refrigerant that flows out of the electric three-way valve 13 in the heating mode, the first dehumidification mode, or the second dehumidification mode. A capillary tube, an orifice, or the like may be used as the fixed throttle 14. Obviously, an electric variable throttle mechanism whose throttle path area is adjusted by a control signal output from the air-conditioning control device 50 may be employed as the decompression means for heating and dehumidification. The refrigerant outlet side of the fixed throttle 14 is connected to the refrigerant inflow outlet of a later-described third three-way joint 23.

The first three-way joint 15 has three refrigerant inflow outlets and functions as a joint for branching a refrigerant flow path. This three-way joint may be formed by joining refrigerant pipes or by attaching a plurality of refrigerant paths to a metal block or a plastic block. Another refrigerant inflow outlet of the first three-way joint 15 is connected to one refrigerant inflow outlet of an outdoor heat exchanger 16. Still another refrigerant inflow outlet of the first three-way joint 15 is connected to the refrigerant inlet side of a low-voltage solenoid valve 17.

The low-voltage solenoid valve 17 includes a valve body, which opens and closes a refrigerant flow path, and a solenoid (coil), which drives the valve body. The low-voltage solenoid valve 17 acts as a refrigerant circuit selection means whose operation is controlled by a control voltage output from the air-conditioning control device 50. More specifically, the low-voltage solenoid valve 17 is configured as a so-called normally-closed valve that opens in an energized state and closes in a de-energized state.

The refrigerant outlet side of the low-voltage solenoid valve 17 is connected to one refrigerant inflow outlet of a later-described fifth three-way joint 28 through a first check valve 18. The first check valve 18 permits the refrigerant to flow in a single direction from the low-voltage solenoid valve 17 side to the fifth three-way joint 28 side.

The outdoor heat exchanger 16 is disposed in the engine room to provide heat exchange between the internally distributed refrigerant and outer air (air taken in from the outside of the passenger compartment and supplied from a blower fan 16a). The blower fan 16a is an electric blower whose rotation speed (the amount of blown air) is controlled by a control voltage output from the air-conditioning control device 50.

It should also be noted that the blower fan 16a according to the present embodiment supplies the outer air not only to the outdoor heat exchanger 16 but also to a radiator (not shown) that dissipates the heat of cooling water for the engine EG. Specifically, the air taken in from the outside of the passenger compartment and supplied from the blower fan 16a flows to the outdoor heat exchanger 16 and then to the radiator. The radiator is connected to a cooling water piping that forms a cooling water circuit 40 indicated by broken lines in FIGS. 1 to 4. The cooling water circuit 40 will be described later.

A cooling water pump is disposed in the cooling water circuit, which is indicated by the broken lines in FIGS. 1 to 4, to circulate the cooling water. The cooling water pump 40a is an electric water pump whose rotation speed (cooling water circulation volume) is controlled by a control voltage output from the air-conditioning control device 50.

The other refrigerant inflow outlet of the outdoor heat exchanger 16 is connected to one refrigerant inflow outlet of a second three-way joint 19. The basic configuration of the second three-way joint 19 is the same as that of the first three-way joint 15. Another refrigerant inflow outlet of the second three-way joint 19 is connected to the refrigerant inlet side of a high-voltage solenoid valve 20. Still another refrigerant inflow outlet of the second three-way joint 19 is connected to one refrigerant inflow outlet of a heat exchanger shut-off solenoid valve 21.

The high-voltage solenoid valve 20 and the heat exchanger shut-off solenoid valve 21 are refrigerant circuit selection means whose operation is controlled by a control voltage output from the air-conditioning control device 50. The high-voltage solenoid valve 20 and the heat exchanger shut-off solenoid valve 21 have the same basic configuration as the low-voltage solenoid valve 17. However, the high-voltage solenoid valve 20 and the heat exchanger shut-off solenoid valve 21 are configured as a so-called normally-open valve that closes in an energized state and opens in a de-energized state.

The refrigerant outlet side of the high-voltage solenoid valve 20 is connected to the inlet side of a throttle mechanism portion of the later-described thermostatic expansion valve 27 through a second check valve 22. The second check valve 22 permits the refrigerant to flow in a single direction from the high-voltage solenoid valve 20 side to the thermostatic expansion valve 27 side.

The other refrigerant inflow outlet of the heat exchanger shut-off solenoid valve 21 is connected to one refrigerant inflow outlet of the third three-way joint 23. The third three-way joint 23 has the same basic configuration as the first three-way joint 15. Another refrigerant inflow outlet of the third three-way joint 23 is connected to the refrigerant outlet side of the fixed throttle 14 as mentioned earlier. Still another refrigerant inflow outlet of the third three-way joint 23 is connected to the refrigerant inlet side of a dehumidification solenoid valve 24.

The dehumidification solenoid valve 24 is a refrigerant circuit selection means whose operation is controlled by a control voltage output from the air-conditioning control device 50. The basic configuration of the dehumidification solenoid valve 24 is the same as that of the low-voltage solenoid valve 17. The dehumidification solenoid valve 24 is also configured as a normally-closed valve. The refrigerant circuit selection means according to the present embodiment is formed by a plurality of (five) solenoid valves, namely, the electric three-way valve 13, low-voltage solenoid valve 17, high-voltage solenoid valve 20, heat exchanger shut-off solenoid valve 21, and dehumidification solenoid valve 24, which are placed in a predefined open state or closed state when the supply of electrical power is shut off.

The refrigerant outlet side of the dehumidification solenoid valve 24 is connected to one refrigerant inflow outlet of a fourth three-way joint 25. The fourth three-way joint 25 has the same basic configuration as the first three-way joint 15. Another refrigerant inflow outlet of the fourth three-way joint 25 is connected to the outlet side of the throttle mechanism portion of the thermostatic expansion valve 27. Still another refrigerant inflow outlet of the fourth three-way joint 25 is connected to the refrigerant inlet side of the indoor evaporator 26.

The indoor evaporator 26 is a cooling heat exchanger that is mounted in the casing 31 of the indoor air-conditioning unit 30 and disposed upstream of the indoor condenser 12 with respect to the flow of blown air to cool the blown air by heat exchange between the refrigerant distributed in the indoor evaporator 26 and the blown air.

The refrigerant outlet of the indoor evaporator 26 is connected to the inlet side of a thermosensitive-portion of the thermostatic expansion valve 27. The thermostatic expansion valve 27 is a pressure reduction means for cooling that decompresses and expands the refrigerant flowing into the inside from the inlet of the throttle mechanism portion and causes the refrigerant to flow out of the outlet of the throttle mechanism portion.

More specifically, the thermostatic expansion valve 27 according to the present embodiment is an internal pressure balancing expansion valve placed in a housing that contains the thermosensitive portion 27a and the variable throttle mechanism portion 27b. The thermosensitive portion 27a detects the degree of overheat of the refrigerant at the outlet side of the indoor evaporator 26 in accordance with the temperature and pressure of the refrigerant at the outlet side of the indoor evaporator 26. The variable throttle mechanism portion 27b adjusts the throttle path area (refrigerant flow rate) so that the degree of overheat of the refrigerant at the outlet side of the indoor evaporator 26 is within a predetermined range in accordance with the displacement of the thermosensitive portion 27a.

The outlet side of the thermosensitive-portion of the thermostatic expansion valve 27 is connected to one refrigerant inflow outlet of the fifth three-way joint 28. The basic configuration of the fifth three-way joint 28 is the same as that of the first three-way joint 15. Another refrigerant inflow outlet of the fifth three-way joint 28 is connected to the refrigerant outlet side of the first check valve 18 as mentioned earlier. Still another refrigerant inflow outlet of the fifth three-way joint 28 is connected to the refrigerant inlet side of an accumulator 29.

The accumulator 29 is a low-pressure side gas-liquid separator that receives the refrigerant from the fifth three-way joint 28, separates the received refrigerant into a gas and a liquid, and stores an excess refrigerant. The gas-phase refrigerant outlet of the accumulator 29 is connected to the refrigerant inlet of the compressor 11.

The indoor air-conditioning unit 30 will now be described. The indoor air-conditioning unit 30 is disposed inside an instrument panel at the forefront of the passenger compartment. The casing 31, which is the outer shell of the indoor air-conditioning unit 30, houses, for example, a blower 32, the indoor evaporator 26, the indoor condenser 12, a heater core 36, and a PTC heater 37.

The casing 31 forms a path for the air blown into the passenger compartment, is elastic to a certain degree, and is molded with resin that excels in strength (e.g., polypropylene). An inner/outer air changeover box (not shown) is disposed at the most upstream end within the casing 31 with respect to the flow of blown air to selectively introduce inner air (the air inside the passenger compartment) and outer air (the air outside the passenger compartment).

More specifically, the inner/outer air changeover box is provided with an inner air introduction port for introducing the inner air into the casing 31 and an outer air introduction port for introducing the outer air into the casing 31. Further, an inner/outer air changeover door is disposed in the inner/outer air changeover box to continuously adjust the opening areas of the inner and outer air introduction ports for the purpose of changing the ratio between the amount of inner air introduction and the amount of outer air introduction.

Consequently, the inner/outer air changeover door constitutes an air introduction amount change means for selecting an air inlet mode for the purpose of changing the ratio between the amount of inner air introduction into the casing 31 and the amount of outer air introduction into the casing 31. More specifically, the inner/outer air changeover door is driven by an electric actuator 62 for the inner/outer air changeover door. The operation of the electric actuator 62 is controlled by a control signal output from the air-conditioning control device 50.

Three different air inlet modes are selectable: inner air mode, outer air mode, and inner/outer air mixture mode. The inner air mode fully opens the inner air introduction port and fully closes the outer air introduction port to introduce the inner air into the casing 31. The outer air mode fully closes the inner air introduction port and fully opens the outer air introduction port to introduce the outer air into the casing 31. The inner/outer air mixture mode, which is an intermediate between the inner air mode and the outer air mode, continuously adjusts the opening areas of the inner and outer air introduction ports for the purpose of continuously changing the ratio between the amount of inner air introduction and the amount of outer air introduction.

The blower 32 is disposed downstream of the inner/outer air changeover box with respect to the flow of air and operated so that the air taken in through the inner/outer air changeover box is blown into the passenger compartment. The blower 32 is an electric blower that uses an electric motor to drive a multiblade centrifugal fan (sirocco fan). The rotation speed (an availability factor, that is, an operating rate) of the blower 32 is controlled by a control voltage output from the air-conditioning control device 50. Hence, the air-conditioning control device 50 constitutes a blower control means.

The aforementioned indoor evaporator 26 is disposed downstream of the blower 32 with respect to the flow of air. In addition, air paths, such as a heating cool air path 33 for making the air flow after passing through the indoor evaporator 26 and a cool air bypass path 34, and a mixing space 35, which mixes the air flowing out of the heating cool air path 33 with the air flowing out of the cool air bypass path 34, are formed downstream of the indoor evaporator 26 with respect to the flow of air.

In the heating cool air path 33, the heater core 36, the indoor condenser 12, and the PTC heater 37, which constitute a heating means for heating the air after passing through the indoor evaporator 26, are arranged in the order named with respect to the direction of flow of blown air. The heater core 36 is connected to a cooling water piping that constitutes the cooling water circuit 40, and acts as a heating heat exchanger that heats the air after passing through the indoor evaporator 26 by heat exchange between the cooling water (heat medium) for the engine EG and the air after passing through the indoor evaporator 26.

The cooling water circuit 40 will now be described. The cooling water circuit 40 circulates the cooling water to cool the engine EG. The electric cooling water pump 40a, which pumps the cooling water, is disposed in the cooling water piping of the cooling water circuit 40. The rotation speed (water pumping capability) of the cooling water pump 40a is controlled by a control voltage output from the air-conditioning control device 50.

When the air-conditioning control device 50 operates the cooling water pump 40a, the cooling water, which is heated by the waste heat of the engine EG, flows into the radiator or the heater core 36. The cooling water is then cooled by the radiator or by the heater core 36 and returns to the engine EG.

In other words, the cooling water is a heat source medium that heats the air blown into the passenger compartment by the heater core 36. A portion of the cooling water circuit 40 that is indicated by the broken lines in FIGS. 1 to 4, which is a circuit for circulating the cooling water from the cooling water pump 40a through the heater core 36 and the engine EG to the cooling water pump 40a, constitutes a temperature regulation means for adjusting the temperature of the blown air.

The PTC heater 37 is an electric heater that includes a PTC element (positive temperature coefficient thermistor) and serves as an auxiliary heating means. When electrical power is supplied to the PTC element, the PTC heater 37 generates heat and heats the air after passing through the indoor condenser 12. The present embodiment uses a plurality of units of the PTC heater 37 (actually three PTC heaters). The air-conditioning control device 50 controls the overall heating capability (an availability factor, that is, an operating rate) of the PTC heater 37 by changing the number of energized units of the PTC heater 37.

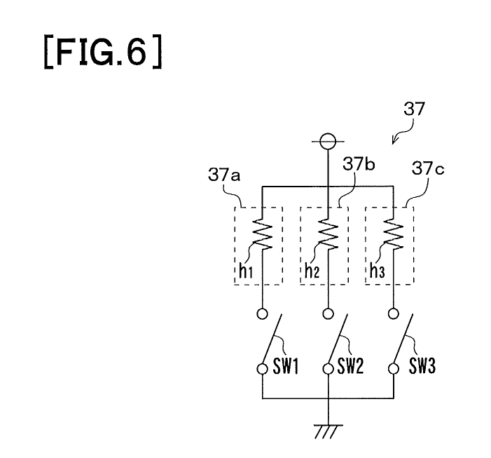

More specifically, the PTC heater 37 includes a plurality of (three in the present embodiment) PTC heaters 37a, 37b, 37c as shown in FIG. 6. FIG. 5 is a circuit diagram illustrating the electrical connection of the PTC heater 37 according to the present embodiment. The electrical power consumption required for operating the PTC heater 37 according to the present embodiment is lower than required for operating the compressor 11 in the refrigeration cycle 10.

As shown in FIG. 6, the positive terminal side of each PTC heater 37a, 37b, 37c is connected to the battery 81, whereas the negative terminal side is connected to a ground side through a respective switch element SW1, SW2, SW3 included in each PTC heater 37a, 37b, 37c. Each switch element SW1, SW2, SW3 switches each PTC element h1, h2, h3 included in each PTC heater 37a, 37b, 37c between an energized state (ON state) and a de-energized state (OFF state).

The operation of each switch element SW1, SW2, SW3 is independently controlled by a control signal output from the air-conditioning control device 50. Hence, the air-conditioning control device 50 independently switches each switch element SW1, SW2, SW3 between the energized state and de-energized state. Consequently, the PTC heaters 37a, 37b, 37c can be selectively energized to exercise their heating capability to change the overall heating capability of the PTC heater 37.

Meanwhile, the cool air bypass path 34 is an air path for directly introducing the air after passing through the indoor evaporator 26 into the mixing space 35, bypassing the heater core 36, the indoor condenser 12, and the PTC heater 37. Therefore, the temperature of the blown air mixed in the mixing space 35 varies with the ratio between the amount of air passing through the heating cool air path 33 and the amount of air passing through the cool air bypass path 34.

As such being the case, the present embodiment uses an air mix door 38. The air mix door 38 is disposed downstream of the indoor evaporator 26 with respect to the flow of air and toward the inlets of the heating cool air path 33 and cool air bypass path 34 to continuously vary the ratio between the amount of cool air introduced into the heating cool air path 33 and the amount of cool air introduced into the cool air bypass path 34.

Hence, the air mix door 38 constitutes a temperature regulation means for adjusting the air temperature in the mixing space 35 (the temperature of air blown into the passenger compartment). More specifically, the air mix door 38 is driven by an electric actuator 63 for the air mix door. The operation of the electric actuator 63 is controlled by a control signal output from the air-conditioning control device 50.

Further, air outlets 39 are disposed at the most downstream end of the casing 31 with respect to the flow of blown air. The air outlets blow the temperature-regulated blown air from the mixing space 35 into the passenger compartment, which is a cooling target space. Specifically, three different air outlets are disposed: a face air outlet, a foot air outlet, and a defroster air outlet (none of them is illustrated). The face air outlet blows air-conditioned air toward the upper body of the occupant in the passenger compartment. The foot air outlet blows the air-conditioned air toward the lower body (especially, the feet) of the occupant. The defroster air outlet blows the air-conditioned air toward the inner surface of the vehicle's windshield.

Moreover, a face door (not shown), a foot door (not shown), and a defroster door (not shown) are disposed upstream of the face air outlet, foot air outlet, and defroster air outlet, respectively, with respect to the flow of air. The face door adjusts the opening area of the face air outlet. The foot door adjusts the opening area of the foot air outlet. The defroster door adjusts the opening area of the defroster air outlet.

The face door, the foot door, and the defroster door constitute an air outlet mode selection means for selecting an air outlet mode. These doors are coupled to an electric actuator 64 for driving an air outlet mode door through a link mechanism (not shown) and rotated in conjunction with the electric actuator 64. The operation of the electric actuator 64 is also controlled by a control signal output from the air-conditioning control device 50. Hence, the air-conditioning control device 50 constitutes an air outlet mode selection control means.

Selectable air outlet modes are a face mode, a bi-level mode, a foot mode, and a foot/defroster mode. The face mode fully opens the face air outlet and blows air from the face air outlet toward the upper body of the occupant in the passenger compartment. The bi-level mode opens both the face air outlet and the foot air outlet and blows air toward the upper body and feet of the occupant in the passenger compartment. The foot mode fully opens the foot air outlet, opens the defroster air outlet to a small degree, and blows air mainly out of the foot air outlet. The foot/defroster mode opens the foot air outlet and defroster air outlet to the same degree and blows air out of both the foot air outlet and the defroster air outlet.

In other words, the bi-level mode is an air outlet mode in which the blown air is blown out from both of the face air outlet and the foot air outlet, and the face mode is an air outlet mode in which the proportion of the amount of the air flow blown out from the face air outlet is larger than in the bi-level mode and the proportion of the amount of the air flow blown out from the foot air outlet is smaller than in the bi-level mode.

Further, the occupant can manually operate a switch on a later-described operation panel 60 to select a defroster mode in which the defroster air outlet fully opens to blow air from the defroster air outlet toward the inner surface of the vehicle's windshield.

It should be noted that the hybrid vehicle to which the air conditioner for a vehicle 1 according to the present embodiment is applied includes an electric heating defogger (not shown) separately from the air conditioner for a vehicle. The electric heating defogger is an electric heating wire disposed in or on passenger compartment windows and used to heat the windows for the purpose of defogging the windows or preventing the windows from being fogged. The operation of the electric heating defogger can be controlled by a control signal output from the air-conditioning control device 50.

An electrical control section according to the present embodiment will now be described with reference to FIG. 5. The air-conditioning control device 50 includes a well-known microcomputer and its peripheral circuits, the microcomputer including, for example, a CPU, a ROM, and a RAM. In accordance with an air-conditioning control program stored in the ROM, the air-conditioning control device 50 performs various computations and processes to control the operations of various instruments connected to its output side, such as the inverter 61 of the electric motor 11b for the compressor 11, the solenoid valves 13, 17, 20, 21, 24 constituting the refrigerant circuit selection means, the blower fan 16a, the blower 32, and the electric actuators 62, 63, 64.

The air-conditioning control device 50 is configured integrally with a control means for controlling the above-mentioned instruments. In the present embodiment, however, elements (hardware and software) for controlling the operation (refrigerant discharge capability) of the electric motor 11b, which is a means for changing the discharge capability of the compressor 11, constitute a discharge capability control means 50a. Obviously, the discharge capability control means 50a may be implemented as a unit separate from the air-conditioning control device 50.

The input side of the air-conditioning control device 50 inputs detection signals of various sensors, such as an inner air sensor 51 for detecting a passenger compartment temperature Tr, an outer air sensor 52 (outer air temperature detection means) for detecting an outer air temperature Tam, an insolation sensor 53 for detecting the amount of insolation Ts in the passenger compartment, a discharge temperature sensor 54 (discharge temperature detection means) for detecting the discharged refrigerant temperature Td of the compressor 11, a discharge pressure sensor 55 (discharge pressure detection means) for detecting the discharge side refrigerant pressure (high-pressure side refrigerant pressure) Pd of the compressor 11, an evaporator temperature sensor 56 (evaporator temperature detection means) for detecting a blown air temperature (evaporator temperature) Te from the indoor evaporator 26, an intake air temperature sensor 57 for detecting the temperature Tsi of the refrigerant distributed between the first three-way joint 15 and the low-voltage solenoid valve 17, a cooling water temperature sensor for detecting an engine cooling water temperature Tw, a humidity sensor for detecting the relative humidity of passenger compartment air near the passenger compartment windows, a window vicinity temperature sensor for detecting the temperature of the passenger compartment air near the windows, and a window surface temperature sensor for detecting the surface temperature of the windows.

In the cooling mode, the discharge side refrigerant pressure (high-pressure side refrigerant pressure) Pd of the compressor 11 according to the present embodiment is the high-pressure side refrigerant pressure of the cycle between the refrigerant discharge side of the compressor 11 and the inlet side of the variable throttle mechanism portion 27b for the thermostatic expansion valve 27. In the other operation modes, the discharge side refrigerant pressure (high-pressure side refrigerant pressure) Pd of the compressor 11 according to the present embodiment is the high-pressure side refrigerant pressure of the cycle between the refrigerant discharge side of the compressor 11 and the inlet side of the fixed throttle 14. It should be noted that the discharge pressure sensor 55 is also included in a common refrigeration cycle in order to monitor for an abnormal increase in the high-pressure side refrigerant pressure.

Specifically, the evaporator temperature sensor 56 detects the temperature of a heat exchange fin in the indoor evaporator 26. Obviously, a temperature detection means for detecting the temperature of another part of the indoor evaporator 26 may be used as the evaporator temperature sensor 56. A temperature detection means for directly detecting the temperature of the refrigerant flowing in the indoor evaporator 26 may also be used. Values detected by the humidity sensor, window vicinity temperature sensor, and window surface temperature sensor are used to calculate the relative humidity of a window surface RHW.

The input side of the air-conditioning control device 50 also inputs an operation signal from various air-conditioning operating switches mounted on the operation panel 60 disposed near the instrument panel at the front of the passenger compartment. The air-conditioning operating switches mounted on the operation panel 60 are, for example, an operating switch, an auto switch, an operation mode selector switch, an air outlet mode selector switch, an air flow rate setup switch for the blower 32, a passenger compartment temperature setup switch, and an economy switch. All of these switches are used to operate the air conditioner for a vehicle 1.

The auto switch is used to enter or exit an automatic control mode of the air-conditioner for a vehicle 1. The passenger compartment temperature setup switch is a target temperature setup means that is operated by the occupant to set a target temperature Tset for the passenger compartment. The economy switch is a power saving request means that is turned on by the occupant to output a power saving request signal for the purpose of saving the power required for air-conditioning the passenger compartment.

Further, when the economy switch is turned on, a signal is output in the EV driving mode to the engine control device in order to decrease the frequency of the operation of the engine EG, which is operated to assist the driving electric motor.

As is the case with the air-conditioning control device 50, the engine control device (not shown) includes a well-known microcomputer and its peripheral circuits. In accordance with an engine control program stored in the ROM, the engine control device performs various computations and processes to control the operations of various engine control instruments connected to its output side.

The output side of the engine control device is connected, for instance, to various engine components, which constitute the engine EG. More specifically, the output side of the engine control device is connected, for instance, to a starter (not shown), which starts the engine EG, and to a drive circuit (not shown) for a fuel injection valve (injector), which supplies fuel to the engine EG.

The input side of the engine control device 70 is connected to various engine control sensors, such as a voltmeter (not shown) for detecting the inter-terminal voltage VB of the battery 81, an accelerator opening sensor (not shown) for detecting the degree of accelerator opening Acc, and an engine speed sensor (not shown) for detecting an engine speed Ne.

The air-conditioning control device 50 and the engine control device are electrically connected and capable of electrically communicating with each other. This permits one of these control devices to control the operations of instruments connected to its output side in accordance with a detection signal or operation signal input into the other control device. For example, the air-conditioning control device 50 can operate the engine EG by outputting an engine operation request signal to the engine control device.

The air-conditioning control device 50 and the engine control device are configured integrally with a control means for controlling various control target instruments connected to their output side. However, elements (hardware and software) for controlling the operation of a respective control target instrument constitute a control means for controlling the operation of the respective control target instrument.

For example, elements included in the air-conditioning control device 50 to control the refrigerant discharge capability of the compressor 11 by controlling the frequency of an AC voltage output from the inverter 61 connected to the electric motor 11b for the compressor 11 constitute a compressor control means, and elements included in the air-conditioning control device 50 to control the air blowing capability of the blower 32 by controlling the operation of the blower 32, which is an air blowing means, constitute a blower control means.

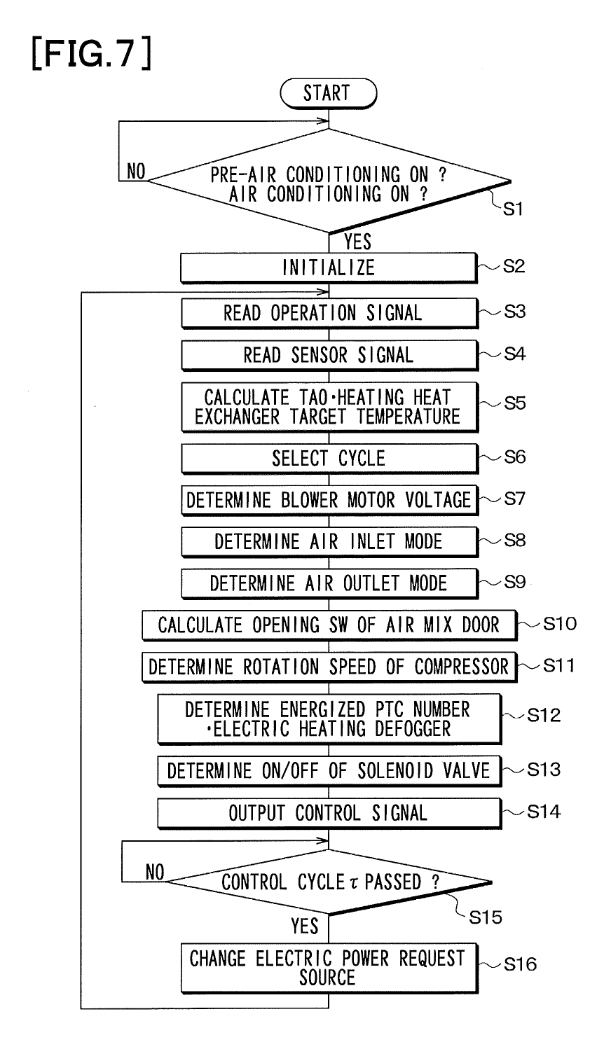

Operations of the present embodiment, which is configured as described above, will now be described with reference to FIG. 7. FIG. 7 is a flowchart illustrating a control process performed by the air conditioner for a vehicle 1 according to the present embodiment. Even when a vehicle system is stopped, this control process is performed as far as electrical power is supplied from the battery to the air-conditioning control device 50.

First of all, step S1 is performed to determine whether the operating switch for the air conditioner for a vehicle 1 is turned on (ON) and whether a start switch for pre-air conditioning is turned on. If the determination result obtained in step S1 indicates that either the operating switch for the air conditioner for a vehicle 1 or the start switch for pre-air conditioning is turned on, processing proceeds to step S2.

The start switch for pre-air conditioning is mounted, for instance, on a wireless terminal (remote controller) or mobile communication means (or more specifically, a cell phone) carried by the occupant. Therefore, the occupant can start the air conditioner for a vehicle 1 from a place remote from the vehicle.

When, for instance, the start switch for pre-air conditioning that is mounted on the wireless terminal is turned on, the vehicle directly receives a pre-air conditioning start signal transmitted from the wireless terminal and concludes that the start switch for pre-air conditioning is turned on. On the other hand, when the start switch for pre-air conditioning that is mounted on the mobile communication means is turned on, the vehicle directly receives a pre-air conditioning start signal transmitted, for instance, through a cell phone base station and concludes that the start switch for pre-air conditioning is turned on.

Further, the air conditioner for a vehicle 1 according to the present embodiment is applied to a plug-in hybrid vehicle. Therefore, when electrical power is supplied to the vehicle from an external power source, pre-air conditioning is continuously provided until a user of the vehicle issues a request for stopping a pre-air conditioning process. When, on the other hand, no electrical power is supplied from an external power source, pre-air conditioning is continuously provided until the amount of electrical power remaining in the battery 81 is not larger than a predetermined amount.

Step S2 is performed to initialize, for example, a flag and a timer and returns, for example, a stepping motor, which is one of the aforementioned electric actuators, to its initial position. When the flag is to be initialized, its current status may be retained depending on the case. Processing then proceeds to step S3. In step S3, the operation signals of the operation panel 60 are read. Processing then proceeds to step S4. The operation signals read in step S3 include a signal indicative of the target temperature (Tset) for the passenger compartment, an air outlet mode selection signal, an air inlet mode selection signal, and a signal for setting the amount of air supplied from the blower 32.

In step S4, vehicle environmental condition signals used for air-conditioning control, namely, the signals detected by the aforementioned sensors 51-57 are read. Processing then proceeds to step S5. In step S5, a target blown air temperature TAO for the air blown into the passenger compartment is calculated. In the heating mode, a heating heat exchanger target temperature is also calculated. The target blown air temperature TAO is calculated from Equation F1 below.

TAO=Kset×Tset−Kr×Tr−Kam×Tam−Ks×Ts+C (F1)

where Tset is a passenger compartment temperature setting selected by the passenger compartment temperature setup switch, Tr is an inner air temperature detected by the inner air sensor 51, Tam is an outer air temperature detected by the outer air sensor 52, and Ts is the amount of insolation detected by the insolation sensor 53. Kset, Kr, Kam, and Ks are control gains. C is a constant for correction.

The heating heat exchanger target temperature is basically calculated from Equation F1 above. In some cases, however, it may be calculated from Equation F1 and then corrected to be a value smaller than TAO for the purpose of reducing the amount of power consumption.

In subsequent steps S6 to S16, the controlled conditions of various instruments connected to the air-conditioning control device 50 are determined. Step 6 is performed in accordance with air-conditioning environmental conditions to select the cooling mode, the heating mode, the first dehumidification mode, or the second dehumidification mode.

For example, the cooling mode should be selected when the face mode is used as an air outlet mode. The heating mode, the first dehumidification mode, or the second dehumidification mode should be selected when the inner air mode is used as an air inlet mode. Further, the heating mode, the first dehumidification mode, and the second dehumidification mode should be selectively used in accordance with the blown air temperature (evaporator temperature) Te from the indoor evaporator 26, which is detected by the evaporator temperature sensor 56.

More specifically, if the blown air temperature Te is higher than a first reference blown air temperature (e.g., 0° C.), the heating mode should be selected because no dehumidification is needed. If the blown air temperature Te is not higher than the first reference blown air temperature and is higher than a second reference blown air temperature (e.g., −1° C.), the first dehumidification mode should be selected because dehumidification is needed. If the blown air temperature Te is not higher than the second reference blown air temperature, the second dehumidification mode in which dehumidification takes precedence over heating should be selected.

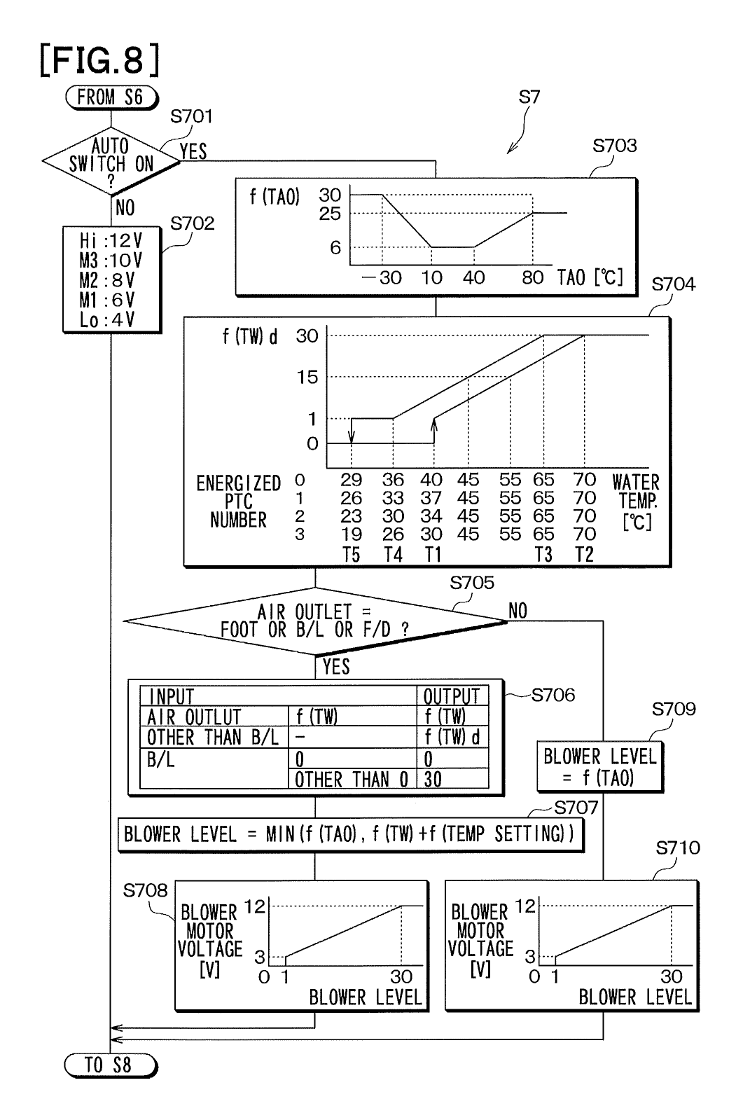

In step S7, the target amount of air blown by the blower 32 is determined. More specifically, a blower motor voltage to be applied to the electric motor for the blower 32 is determined. A control process performed in step S7 will now be described in more detail with reference to FIG. 8. First of all, step S701 is performed to determine whether the auto switch on the operation panel 60 is turned on.

If the determination result obtained in step S701 does not indicate that the auto switch is turned on, processing proceeds to step S702. Step S702 is performed to determine a blower motor voltage that provides an air flow rate desired by the occupant, which is set by the air flow rate setup switch on the operation panel 60. Processing then proceeds to step S8. The air flow rate setup switch according to the present embodiment permits the occupant to sequentially select the Lo, M1, M2, M3, and Hi positions to specify one of five different air flow rates. Selecting the Lo, M1, M2, M3, and Hi positions in sequence gradually raises the blower motor voltage, that is, sequentially selects blower motor voltages of 4 V, 6 V, 8 V, 10 V, and 12 V.

If, on the other hand, the determination result obtained in step S701 indicates that the auto switch is turned on, processing proceeds to step S703. In step S703, a control map stored in the air-conditioning control device 50 is referenced to determine a first tentative blower level f(TAO) in accordance with the target blown air temperature TAO determined in step S4. In other words, the availability factor of the blower 32 is determined based on an air-conditioning load which is a load on the air conditioner.

More specifically, the present embodiment maximizes the first tentative blower level f(TAO) in an extremely low temperature region (maximum cooling region) of the TAO and in an extremely high temperature region (maximum heating region) and exercises control to substantially maximize the air flow rate of the blower 32. Further, if the TAO increases from the extremely low temperature region toward an intermediate temperature region, the present embodiment lowers the first tentative blower level f(TAO) in accordance with an increase in the TAO, thereby decreasing the air flow rate of the blower 32.

Furthermore, if the TAO decreases from the extremely high temperature region toward the intermediate temperature region, the present embodiment lowers the first tentative blower level f(TAO) in accordance with a decrease in the TAO, thereby decreasing the air flow rate of the blower 32. Moreover, if the TAO is within a predetermined intermediate temperature region, the present embodiment minimizes the first tentative blower level f(TAO) to minimize the air flow rate of the blower 32.

In the next step, which is step S704, a second tentative blower level f(TW)d is determined. The second tentative blower level f(TW)d is used in the heating mode to adjust the blower level in accordance with the engine cooling water temperature Tw and with the number of energized units of the PTC heater 37. In other words, the upper limit value of the availability factor of the blower 32 is determined based on the engine cooling water temperature Tw.

In the present embodiment, a diagram depicting the relationship between the engine cooling water temperature Tw and the second tentative blower level f(TW)d, which is shown under step S704, is complied with. More specifically, if the engine cooling water temperature Tw is in a low temperature region lower than a predetermined first reference temperature T1, the blower level is set to level 0 (zero), namely, the blower 32 is stopped. If, on the other hand, the engine cooling water temperature Tw is not lower than the first reference temperature T1, the second tentative blower level f(TW)d is determined in such a manner that the blower level rises in accordance with an increase in the engine cooling water temperature Tw. In other words, when the engine cooling water temperature Tw becomes equal to or larger than the first reference temperature T1, the second tentative blower level f(TW)d is determined so that the smaller the engine cooling water temperature Tw is, the further the availability factor of the blower 32 is limited.

As such being the case, the operation of the blower 32 can be stopped when the heater core 36 cannot heat the blown air because the temperature of the cooling water flowing in the heater core 36 is lower than the first reference temperature T1. This makes it possible to inhibit the occupant from feeling improperly air-conditioned as insufficiently heated air is blown toward the occupant.

If, in the above instance, the PTC heater 37 is energized, it can heat the blown air even when the engine cooling water temperature Tw is low. In step S704, therefore, the first reference temperature T1 is lowered in accordance with an increase in the number of energized units of the PTC heater 37, which is determined in later-described step S12. In other words, the availability factor of the blower 32 is increased with an increase in the availability factor of the PTC heater 37. As a result, the engine cooling water temperature Tw at which the blower 32 starts running decreases with an increase in the number of energized units of the PTC heater 37.

Further, in a high temperature region in which the engine cooling water temperature Tw is not lower than the first reference temperature T1, the blower level rises at a constant rate in accordance with an increase in the engine cooling water temperature Tw no matter whether the PTC heater 37 is energized. In other words, when the engine cooling water temperature Tw is not lower than the first reference temperature T1, the degree of increase in the availability factor of the blower 32 with respect to increase in the availability factor of the PTC heater 37 is smaller than when the engine cooling water temperature Tw is lower than the first reference temperature T1.

More specifically, if the engine cooling water temperature Tw is lower than the first reference temperature T1 in a situation where the engine cooling water temperature Tw is rising, the second tentative blower level f(TW)d is set to level 0 (zero) to stop the operation of the blower 32. In this instance, setup is performed so that the first reference temperature T1 sequentially decreases from 40° C. through 37° C. and 34° C. to 30° C. when the number of energized units of the PTC heater 37 increases from 0 (zero) through 1 and 2 to 3.

If, on the other hand, the engine cooling water temperature Tw is not lower than the first reference temperature T1, the second tentative blower level f(TW)d is gradually increased with an increase in the engine cooling water temperature Tw without regard to the number of energized units of the PTC heater 37. If the engine cooling water temperature Tw rises to a second reference temperature T2 (e.g., 70° C.) or higher, the second tentative blower level f(TW)d is set to a maximum value (e.g., level 30).

Meanwhile, if the engine cooling water temperature Tw is not higher than a third reference temperature T3 (e.g., 65° C.) in a situation where the engine cooling water temperature Tw is lowering, the second tentative blower level f(TW)d is gradually decreased with a decrease in the engine cooling water temperature Tw. If the engine cooling water temperature Tw is lower than a fourth reference temperature T4 and not lower than a fifth reference temperature T5, the second tentative blower level f(TW)d is set to an extremely small value (e.g., level 1).

In the above instance, setup is performed so that the fourth reference temperature T4 sequentially decreases from 36° C. through 33° C. and 30° C. to 26° C. when the number of energized units of the PTC heater 37 increases from 0 (zero) through 1 and 2 to 3. Setup is also performed so that the fifth reference temperature T5 sequentially decreases from 29° C. through 26° C. and 23° C. to 19° C. when the number of energized units of the PTC heater 37 increases from 0 (zero) through 1 and 2 to 3.

If the engine cooling water temperature Tw is lower than the fifth reference temperature T5, the second tentative blower level f(TW)d is set to level 0 (zero) to stop the operation of the blower 32. The relationship between the first to fifth reference temperatures is such that T2>T3>T1>T4>T5. The differences between the reference temperatures are set as a hysteresis width to prevent control hunting.

The next step, which is step S705, is performed to determine whether the air outlet mode, which is to be determined in later-described step S9, is one of the foot mode, bi-level mode, and foot/defroster mode. If the determination result obtained in step S705 indicates that the air outlet mode is one of the foot mode, bi-level mode, and foot/defroster mode, processing proceeds to step S706.

In step S706, a control map stored in the air-conditioning control device 50 beforehand is referenced to determine a third tentative blower level f(TW) based on the air outlet mode and the second tentative blower level f(TW)d that is determined in step S704.

More specifically, in step S706, the third tentative blower level f(TW) is set to be equal to the second tentative blower level f(TW)d when the air outlet mode is other than the bi-level mode. In addition, the third tentative blower level f(TW) is set to a minimum value (0 level in this example) when the air outlet mode is the bi-level mode and the second tentative blower level f(TW)d is a minimum value (0 level in this example).

In addition, the third tentative blower level f(TW) is set to a maximum value (30 level in this example) when the air outlet mode is the bi-level mode and the second tentative blower level f(TW)d is other than the minimum value (other than 0 level in this example). In other words, the upper limit value of the availability factor of the blower 32 is determined to be equal to or larger than the availability factor of the blower 32 that is determined based on the air-conditioning load.

This makes it possible, when the air outlet mode is the bi-level mode, to cancel the effect of the limitation on the availability factor of the blower 32 that is caused by the second tentative blower level f(TW)d in step S704. Therefore, it is possible to increase the amount of the air flow blown out from the face air outlet even if the temperature of the cooling water that flows through the heater core 36 is not sufficiently high. As a result, it is possible to improve comfort of the occupant when solar radiation is strong.

In addition, in the case that the temperature of the cooling water flowing through the heater core 36 is smaller than the first reference temperature T1 or the fifth reference temperature T5 and that it is hence impossible to heat the blown air by means of the heater core 36, the limitation on the availability factor of the blower 32 that is caused by the second tentative blower level f(TW)d at step S704 comes into effect even if the air outlet mode is the bi-level mode. This makes it possible to inhibit the occupant from feeling improperly air-conditioned as unheated air is blown from the foot air outlet to the feet of the occupant.

At this time, as is described in connection with step S704, the first reference temperature T1 and the fifth reference temperature T5 are decreased as the number of energized units of the PTC heater 37 increases. This makes it possible that the effect of the limitation on the availability factor of the blower 32 caused by the second tentative blower level f(TW)d at step S704 is canceled at a lower engine cooling water temperature in accordance with increase of the number of energized units of the PTC heater 37 and that comfort of the occupant is hence improved when solar radiation is strong.

In step S707, the first tentative blower level f(TAO) determined in step S703 is compared to the third tentative blower level f(TW) determined in step S706. The smaller of these two values is then determined as the current blower level, and processing proceeds to step S708.

In step S708, the control map stored in the air-conditioning control device 50 is referenced to determine the blower motor voltage in accordance with the current blower level determined in step S707. Processing then proceeds to step S8.

More specifically, if, in step S708, the blower level is lower than level 1, the blower motor voltage is set to a voltage of 0 V. If, on the other hand, the blower level is not lower than level 1, the blower motor voltage is increased with an increase in the blower level. If the blower level is higher than level 30, the blower motor voltage is set to a maximum voltage (12 V).

Meanwhile, if the determination result obtained in step S705 does not indicate that the air outlet mode is one of the foot mode, bi-level mode, and foot/defroster mode, processing proceeds to step S709.

In step S709, the first tentative blower level f(TAO) determined in step S703 is determined as the current blower level. Processing then proceeds to step S710. In other words, if the air outlet mode is neither the foot mode, nor the bi-level mode, nor the foot/defroster mode, that is, the heating mode is not selected, the first tentative blower level f(TAO) is determined as the current blower level without regard to the second tentative blower level f(TW)d for adjusting the blower level in the heating mode.

In step S710, the control map stored in the air-conditioning control device 50 is referenced to determine the blower motor voltage in accordance with the current blower level determined in step S709, as is the case with step S708. Processing then proceeds to step S8. The control map used in step S710 will not be described because it is the same as the control map used in step S708.

In step S8, the air inlet mode, that is, the status of the inner/outer air changeover box, is determined. The control map stored in the air-conditioning control device 50 is also referenced to determine the air inlet mode in accordance with the TAO. In the present embodiment, the outer air mode, which introduces the outer air, is preferentially selected under normal conditions. However, if, for instance, a high cooling performance is to be provided as the TAO is in an extremely low temperature region, the inner air mode, which introduces the inner air, is selected. An alternative is to provide an exhaust gas concentration detection means for detecting the exhaust gas concentration in the outer air and select the inner air mode when the exhaust gas concentration is not lower than a predetermined reference concentration.

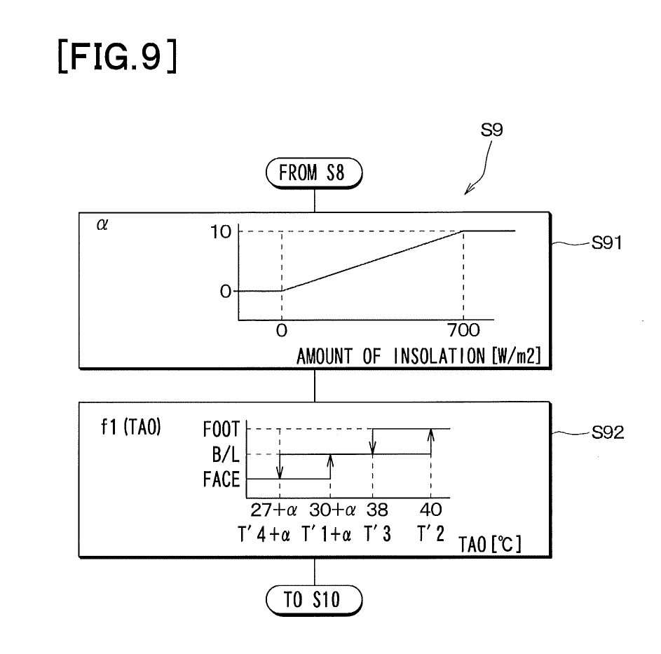

In step S9, the air outlet mode is determined. A control process performed in step S9 will now be described in detail with reference to FIG. 9. First of all, in step S91, a control map stored in the air-conditioning control device 50 is referenced to determine a correction value cc which is used at step S92 which is described later.

More specifically, the correction value cc is determined to be a minimum level (0 in this example) when the amount of insolation is in a low insolation amount range which is smaller than a predetermined first reference value (0 W/im² in this example), determined to be a maximum level (10 in this example) when the amount of insolation is in a high insolation amount range which is larger than a predetermined second reference value (700 W/im² in this example), and determined so that the correction value cc increases in accordance with increase of the amount of insolation when the amount of insolation is equal to or larger than the first reference value and equal to or smaller than the second reference value.

In the next step S92, a control map stored beforehand in the air-conditioning control device 50 is referenced to determine a current air outlet mode f1(TAO) based on the TAO and the correction value α. Processing then proceeds to step S10

More specifically, in a situation where the TAO is increasing, the face mode is selected if the TAO≦first predetermined temperature T′1+the correction value α (e.g., 30+α° C.), the bi-level mode is selected if a first predetermined temperature T′1+the correction value α<TAO≦second predetermined temperature T′2 (e.g., 40° C.), and the foot mode is selected if the second predetermined temperature T′2<TAO.

On the other hand, in a situation where the TAO is decreasing, the foot mode is selected if a third temperature T′3 (e.g., 38° C.)≦TAO, the bi-level mode is selected if a fourth predetermined temperature T′4+the correction value α(e.g., 27+α° C.)≦TAO<third predetermined temperature T′3, and the face mode is selected if the TAO<fourth predetermined temperature T′4+the correction value α. The relationship between the first to fourth predetermined temperatures is such that T′4<T′1<T′3<T′2. The differences between the reference temperatures are set as a hysteresis width to prevent control hunting.

With this operation, in accordance with increase of the amount of the insolation, a range of an air-conditioning load in which the air outlet mode is determined to be the bi-level mode is narrowed down, and a range of an air-conditioning load in which the air outlet mode is determined to be the face mode is widened. Therefore, in accordance with increase of the amount of insolation, it becomes more unlikely that the air outlet mode is determined to be the bi-level mode, and it becomes more likely that the air outlet mode is determined to be the face mode. Therefore, it is possible to improve comfort of the occupant by increasing the amount of the air flow blown out from the face air outlet when solar radiation is strong.

In addition, since the proportion of the amount of the air flow blown out from the foot air outlet is smaller in the face mode than in the bi-level mode, it is possible to ease the occupant's feeling that his/her feet is receiving cold wind if it becomes more likely that the air outlet mode is determined to be the face mode.

In step S10, a target opening SW of the air mix door 38 is calculated in accordance with the TAO, with the blown air temperature Te from the indoor evaporator 26, which is detected by the evaporator temperature sensor 56, and with a heater temperature.

The heater temperature is a value determined in accordance with the heating capability of a heating means (heater core 36, indoor condenser 12, and PTC heater 37) disposed in the heating cool air path 33. In general, the engine cooling water temperature Tw may be used as the value of the heater temperature. Accordingly, the target opening SW can be calculated from Equation F2 below.

SW=[(TAO−Te)/(Tw−Te)]×100(%) (F2)

When SW=0(%), it represents a maximum cooling position of the air mix door 38, fully opens the cool air bypass path 34, and fully closes the heating cool air path 33. On the other hand, when SW=100(%), it represents a maximum heating position of the air mix door 38, fully closes the cool air bypass path 34, and fully opens the heating cool air path 33.

In step S11, the refrigerant discharge capability of the compressor 11 (or more specifically, the rotation speed of the compressor 11) is determined. A basic method of determining the rotation speed of the compressor 11 will now be described. In the cooling mode, for example, the control map stored in the air-conditioning control device 50 is referenced to determine a target blown air temperature TEO for the blown air temperature Te from the indoor evaporator 26 in accordance, for instance, with the TAO determined in step S4.

Next, the deviation En (TEO−Te) between the target blown air temperature TEO and the blown air temperature Te is calculated. A deviation change rate Edot (En−(En−1)) is then determined by subtracting a previously calculated deviation En−1 from the currently calculated deviation En. The deviation change rate Edot (En−(En−1)) is eventually used to determine the amount of rotation speed change Δf_C from a previous compressor rotation speed fCn−1 in accordance with a fuzzy inference based on membership functions and rules stored in the air-conditioning control device 50.

Further, in the heating mode, in the first dehumidification mode, and in the second dehumidification mode, the control map stored in the air-conditioning control device 50 is referenced to determine a target high pressure PDO for the discharge side refrigerant pressure (high-pressure side refrigerant pressure) Pd in accordance, for instance, with the heating heat exchanger target temperature determined in step S4.

Next, the deviation Pn (PDO−Pd) between the target high pressure PDO and the discharge side refrigerant pressure Pd is calculated. A deviation change rate Pdot (Pn−(Pn−1)) is then determined by subtracting a previously calculated deviation Pn−1 from the currently calculated deviation Pn. The deviation change rate Pdot (Pn−(Pn−1)) is eventually used to determine the amount of rotation speed change Δf_H from a previous compressor rotation speed fHn−1 in accordance with a fuzzy inference based on the membership functions and rules stored in the air-conditioning control device 50.

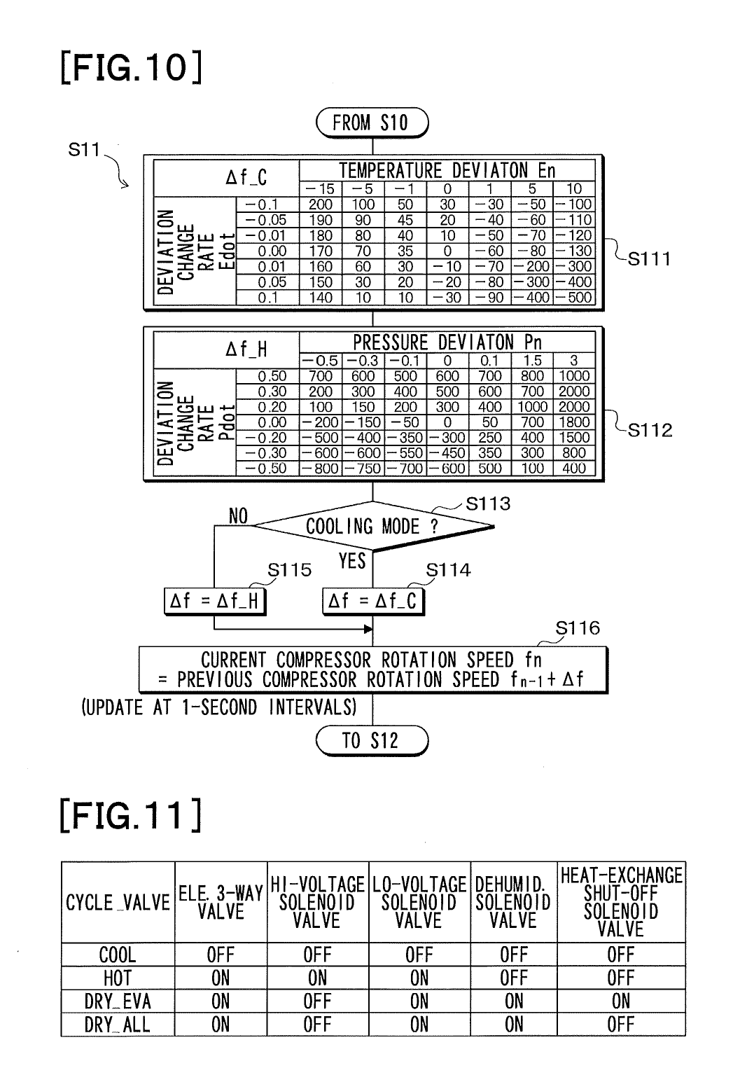

A control process performed in step S11 will now be described in more detail with reference to FIG. 10. First of all, in step S111, the amount of rotation speed change Δf_C in the cooling mode (COOL cycle) is determined. A fuzzy rule table, which is used as a set of rules, is shown under step S111 of FIG. 10. This rule table determines the Δf_C in such a manner as to prevent frost formation on the indoor evaporator 26 in accordance with the aforementioned deviation En and deviation change rate Edot.

In step S112, the amount of rotation speed change Δf_H in the heating mode (HOT cycle), in the first dehumidification mode (DRY_EVA cycle), and in the second dehumidification mode (DRY_ALL cycle) is determined. A fuzzy rule table, which is used as a set of rules, is shown under step S112 of FIG. 10. This rule table determines the Δf_H in such a manner as to avoid an abnormal increase in the high-pressure side refrigerant pressure Pd in accordance with the aforementioned deviation Pn and deviation change rate Pdot.

The next step, which is step S113, is performed to determine whether the operation mode determined in step S6 is the cooling mode. If the determination result obtained in step S113 indicates that the operation mode determined in step S6 is the cooling mode, processing proceeds to step S114. In step S114, the amount of rotation speed change Δf in the compressor 11 is determined as the Δf_C. Processing then proceeds to step S116.

If, on the other hand, the determination result obtained in step S113 does not indicate that the operation mode determined in step S6 is the cooling mode, processing proceeds to step S115. In step S115, the amount of rotation speed change Δf in the compressor 11 is determined as the Δf_H. Processing then proceeds to step S116.

In step S116, the amount of rotation speed change Δf is added to a previous compressor rotation speed fn−1. The resultant value is determined as the current compressor rotation speed fn. Processing then proceeds to step S12. A tentative compressor rotation speed determination in step S116 is not performed on every control cycle τ, but is performed at predetermined control intervals (at 1-second intervals in the present embodiment).

In step S12, the number of energized units of the PTC heater 37 and the operating status of the electric heating defogger are determined. If, for instance, the heating heat exchanger target temperature is not obtained even when the target opening SW for the air mix door 38 is 100% in the heating mode in a situation where the PTC heater needs to be energized in step S6, the number of energized units of the PTC heater 37 should be determined in accordance with the difference between the inner air temperature Tr and the heating heat exchanger target temperature.

Further, if it is highly probable that the windows will be fogged due to the humidity and temperature in the passenger compartment or if the windows are fogged, the electric heating defogger is energized.

In step S13, the operating status of each solenoid valve 13-24, which is the refrigerant circuit selection means, is determined in accordance with the operation mode determined in step S6.

More specifically, if the cooling mode is determined as the operation mode, all the solenoid valves are de-energized as indicated in the table of FIG. 11. If the heating mode is determined as the operation mode, the electric three-way valve 13, the high-voltage solenoid valve 20, and the low-voltage solenoid valve 17 are energized, whereas the remaining solenoid valves 21, 24 are de-energized.

If the first dehumidification mode is determined as the operation mode, the electric three-way valve 13, the low-voltage solenoid valve 17, the dehumidification solenoid valve 24, and the heat exchanger shut-off solenoid valve 21 are energized, whereas the high-voltage solenoid valve 20 are de-energized. If the second dehumidification mode is determined as the operation mode, the electric three-way valve 13, the low-voltage solenoid valve 17, and the dehumidification solenoid valve 24 are energized, whereas the remaining solenoid valves 20, 21 are de-energized.

In other words, the present embodiment is configured so as to shut off the power supply to at least one of the solenoid valves 13-24 no matter what operation mode is selected for refrigerant circuit selection purposes. This makes it possible to reduce the total power consumption of the solenoid valves 13-24 according to the present embodiment.

In step S14, the air-conditioning control device 50 outputs control signals and control voltages to various instruments 61, 13, 17, 20, 21, 24, 16a, 32, 62, 63, 64 in order to provide the controlled conditions determined in steps S6 to S13. For example, a control signal is output to the inverter 61 of the electric motor 11b for the compressor 11 so that the rotation speed of the compressor 11 coincides with the rotation speed determined in step S11.

Next, step S15 is performed to wait for a control cycle T. When the control cycle τ is found to have elapsed, processing proceeds to step S16. In the present embodiment, it is assumed that the control cycle τ is 250 ms. The reason is that passenger compartment air-conditioning control is not adversely affected even if it is exercised on a slower control cycle than, for example, engine control. In addition, the amount of communication for passenger compartment air-conditioning control can be restricted to provide an adequate amount of communication for an engine control system or other control system that has to exercise high-speed control.

If overcharging occurs due to excessive power supply from an external source in a situation where the employed vehicle is a plug-in hybrid vehicle according to the present embodiment or other vehicle that can use the battery 81 to store electrical power supplied from the external power source, a problem occurs with the battery 81 as it generates heat, emits smoke, ignites, or deteriorates. To avoid such a problem, the engine control device controls the amount of electrical power to be supplied from the external power source in compliance with a request, that is, the amount of the electrical power to be supplied from the external power source in accordance, for instance, with a detection signal generated from a wattmeter for detecting the amount of electrical power supplied from the external power source.

Further, if overdischarging occurs due to excessive power consumption of the electrically-operated instruments 11, 16a, 32, 40a of the air condition for a vehicle 1, a problem occurs with the battery 81 as it shortens its useful life even when electrical power is supplied from the external power source. As such being the case, the air-conditioning control device 50 according to the present embodiment performs step S16 to output a signal to the engine control device to change its requested electrical power when the air conditioner for a vehicle 1 is operated while electrical power is supplied from the external power source.

As the air conditioner for a vehicle 1 according to the present embodiment is controlled as described above, it operates as described below depending on the operation mode selected in control step S6.

### (a) Cooling Mode (COOL Cycle; See FIG. 1)

In the cooling mode, the air-conditioning control device 50 de-energizes all the solenoid valves. Therefore, the electric three-way valve 13 connects the refrigerant outlet side of the indoor condenser 12 to one refrigerant inflow outlet of the first three-way joint 15. Further, the low-voltage solenoid valve 17 closes, the high-voltage solenoid valve 20 opens, the heat exchanger shut-off solenoid valve 21 opens, and the dehumidification solenoid valve 24 closes.

Hence, a vapor compression type refrigeration cycle is formed as indicated by the arrows in FIG. 1 so that the refrigerant sequentially circulates from the compressor 11 through the indoor condenser 12, the electric three-way valve 13, the first three-way joint 15, the outdoor heat exchanger 16, the second three-way joint 19, the high-voltage solenoid valve 20, the second check valve 22, the variable throttle mechanism portion 27b of the thermostatic expansion valve 27, the fourth three-way joint 25, the indoor evaporator 26, the thermosensitive portion 27a of the thermostatic expansion valve 27, the fifth three-way joint 28, and the accumulator 29 to the compressor 11.

In the above-described refrigerant circuit in the cooling mode, the refrigerant flowing from the electric three-way valve 13 to the first three-way joint 15 does not flow toward the low-voltage solenoid valve 17 because the low-voltage solenoid valve 17 is closed. Further, the refrigerant flowing from the outdoor heat exchanger 16 to the second three-way joint 19 does not flow toward the heat exchanger shut-off solenoid valve 21 because the dehumidification solenoid valve 24 is closed. Furthermore, the refrigerant flowing out of the variable throttle mechanism portion 27b of the thermostatic expansion valve 27 does not flow toward the dehumidification solenoid valve 24 because the dehumidification solenoid valve 24 is closed. Moreover, the refrigerant flowing from the thermosensitive portion 27a of the thermostatic expansion valve 27 to the fifth three-way joint 28 does not flow toward the second check valve 22 because of an action performed by the second check valve 22.

Consequently, the refrigerant compressed by the compressor 11 is cooled by heat exchange with the blown air (cool air) after passing through the indoor evaporator 26, forwarded to the outdoor heat exchanger 16, further cooled by heat exchange with the outer air, and decompressed and expanded by the thermostatic expansion valve 27. The low-pressure refrigerant, which is decompressed by the thermostatic expansion valve 27, flows into the indoor evaporator 26, and evaporates as it absorbs heat from the air blown from the blower 32. In this manner, the blown air passing through the indoor evaporator 26 is cooled.

In the above instance, the opening of the air mix door 38 is adjusted as mentioned earlier. Therefore, part (or whole) of the blown air cooled by the indoor evaporator 26 flows from the cool air bypass path 34 into the mixing space 35. Further, part (or whole) of the blown air cooled by the indoor evaporator 26 flows into the heating cool air path 33, becomes reheated when it passes through the heater core 36, the indoor condenser 12, and the heater core 36, and then flows into the mixing space 35.

Consequently, the temperature of the air to be blown into the passenger compartment after being mixed in the mixing space 35 is adjusted to a desired level for cooling the passenger compartment. The cooling mode excels in the capability of dehumidifying the blown air, but hardly delivers a heating capability.

The refrigerant flowing out of the indoor evaporator 26 flows into the accumulator 29 through a thermosensitive portion 27a of the thermostatic expansion valve 27. A gas-phase refrigerant, which is derived from gas-liquid separation in the accumulator 29, is taken into the compressor 11 and compressed again.

In the above-described refrigerant circuit in the cooling mode, two separate portions in the refrigerant flow path within the refrigeration cycle 10 are in communication with each other as is obvious from FIG. 1. In other words, a lockout circuit, which does not communicate with a separate portion in the refrigerant flow path within the refrigeration cycle 10, is not formed in the refrigerant circuit in the cooling mode.

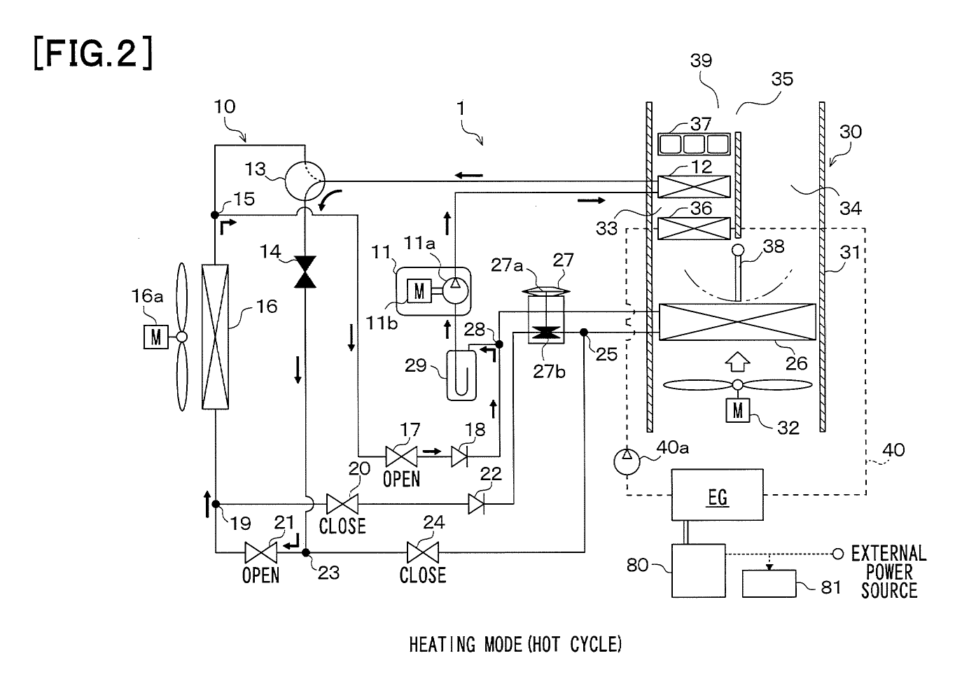

### (b) Heating Mode (HOT Cycle; See FIG. 2)

In the heating mode, the air-conditioning control device 50 energizes the electric three-way valve 13, the high-voltage solenoid valve 20, and the low-voltage solenoid valve 17, and de-energizes the remaining solenoid valves 21, 24. Therefore, the electric three-way valve 13 connects the refrigerant outlet side of the indoor condenser 12 to the refrigerant inlet side of the fixed throttle 14. Further, the low-voltage solenoid valve 17 opens, the high-voltage solenoid valve 20 closes, the heat exchanger shut-off solenoid valve 21 opens, and the dehumidification solenoid valve 24 closes.

Hence, a vapor compression type refrigeration cycle is formed as indicated by the arrows in FIG. 2 so that the refrigerant sequentially circulates from the compressor 11 through the indoor condenser 12, the electric three-way valve 13, the fixed throttle 14, the third three-way joint 23, the heat exchanger shut-off solenoid valve 21, the second three-way joint 19, the outdoor heat exchanger 16, the first three-way joint 15, the low-voltage solenoid valve 17, the first check valve 18, the fifth three-way joint 28, and the accumulator 29 to the compressor 11.

In the above-described refrigerant circuit in the heating mode, the refrigerant flowing from the fixed throttle 14 to the third three-way joint 23 does not flow toward the dehumidification solenoid valve 24 because the dehumidification solenoid valve 24 is closed. Further, the refrigerant flowing from the heat exchanger shut-off solenoid valve 21 to the second three-way joint 19 does not flow toward the high-voltage solenoid valve 20 because the high-voltage solenoid valve 20 is closed. Furthermore, the refrigerant flowing from the outdoor heat exchanger 16 to the first three-way joint 15 does not flow toward the electric three-way valve 13 because the electric three-way valve 13 is connected between the refrigerant outlet side of the indoor condenser 12 and the refrigerant inlet side of the fixed throttle 14. Moreover, the refrigerant flowing from the first check valve 18 to the fifth three-way joint 28 does not flow toward the thermostatic expansion valve 27 because the dehumidification solenoid valve 24 is closed.

Consequently, the refrigerant compressed by the compressor 11 is cooled in the indoor condenser 12 by heat exchange with the blown air supplied from the blower 32. Hence, the blown air passing through the indoor condenser 12 is heated. In this instance, the opening of the air mix door 38 is adjusted. Therefore, as is the case with the cooling mode, the temperature of the air to be blown into the passenger compartment after being mixed in the mixing space 35 is adjusted to a desired level for heating the passenger compartment. The heating mode does not exercise a function of dehumidifying the blown air.

The refrigerant flowing out of the indoor condenser 12 flows into the outdoor heat exchanger 16 after being decompressed by the fixed throttle 14. The refrigerant flowing into the outdoor heat exchanger 16 evaporates as it absorbs heat from the outer air that is blown from the outside of the passenger compartment by the blower fan 16a. The refrigerant flowing out of the outdoor heat exchanger 16 flows into the accumulator 29 through the low-voltage solenoid valve 17, the first check valve 18, and the like. A gas-phase refrigerant, which is derived from gas-liquid separation in the accumulator 29, is taken into the compressor 11 and compressed again.

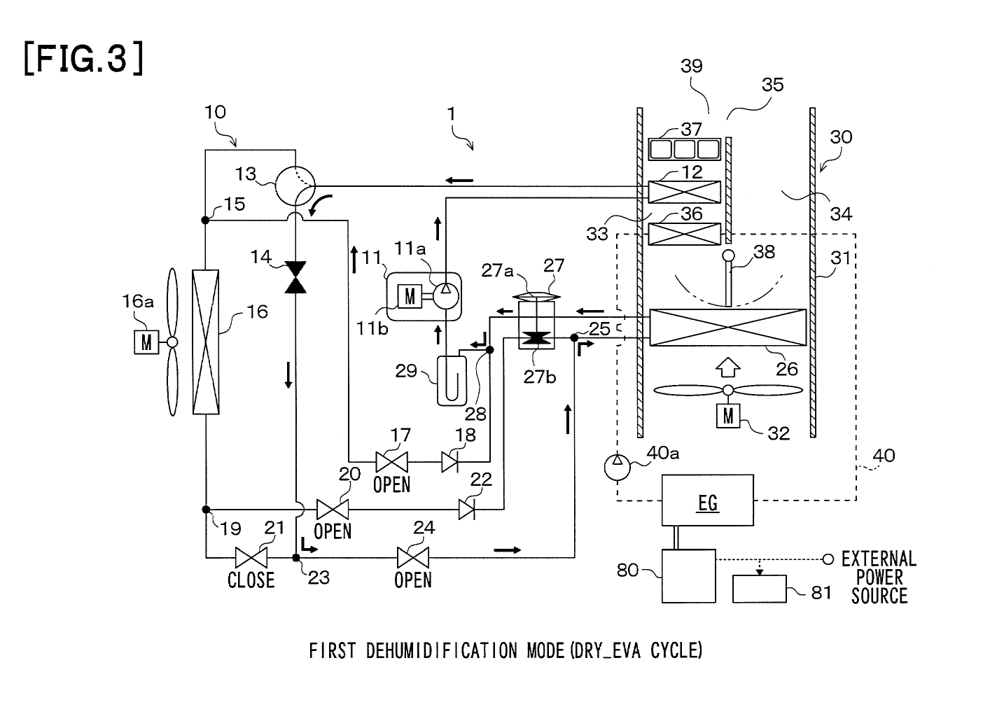

### (c) First Dehumidification Mode (DRY_EVA Cycle; See FIG. 3)

In the first dehumidification mode, the air-conditioning control device 50 energizes the electric three-way valve 13, the low-voltage solenoid valve 17, the heat exchanger shut-off solenoid valve 21, and the dehumidification solenoid valve 24, and de-energizes the high-voltage solenoid valve 20. Therefore, the electric three-way valve 13 connects the refrigerant outlet side of the indoor condenser 12 to the refrigerant inlet side of the fixed throttle 14. Further, the low-voltage solenoid valve 17 opens, the high-voltage solenoid valve 20 opens, the heat exchanger shut-off solenoid valve 21 closes, and the dehumidification solenoid valve 24 opens.

Hence, a vapor compression type refrigeration cycle is formed as indicated by the arrows in FIG. 3 so that the refrigerant sequentially circulates from the compressor 11 through the indoor condenser 12, the electric three-way valve 13, the fixed throttle 14, the third three-way joint 23, the dehumidification solenoid valve 24, the fourth three-way joint 25, the indoor evaporator 26, the thermosensitive portion 27a of the thermostatic expansion valve 27, the fifth three-way joint 28, and the accumulator 29 to the compressor 11.

In the above-described refrigerant circuit in the first dehumidification mode, the refrigerant flowing from the fixed throttle 14 to the third three-way joint 23 does not flow toward the heat exchanger shut-off solenoid valve 21 because the heat exchanger shut-off solenoid valve 21 is closed. Further, the refrigerant flowing from the dehumidification solenoid valve 24 to the fourth three-way joint 25 does not flow toward the variable throttle mechanism portion 27b of the thermostatic expansion valve 27 because of an action performed by the second check valve 22. Furthermore, the refrigerant flowing from the thermosensitive portion 27a of the thermostatic expansion valve 27 to the fifth three-way joint 28 does not flow toward the first check valve 18 because of an action performed by the first check valve 18.

Consequently, the refrigerant compressed by the compressor 11 is cooled in the indoor condenser 12 by heat exchange with the blown air (cool air) after passing through the indoor evaporator 26. This ensures that the blown air passing through the indoor condenser 12 is heated. The refrigerant flowing out of the indoor condenser 12 flows into the indoor evaporator 26 after being decompressed by the fixed throttle 14.

The low-pressure refrigerant flowing into the indoor evaporator 26 evaporates as it absorbs heat from the air blown from the blower 32. This ensures that the blown air passing through the indoor evaporator 26 is cooled and dehumidified. Therefore, the blown air cooled and dehumidified by the indoor evaporator 26 is heated again when it passes through the heater core 36, the indoor condenser 12, and the heater core 36, and is blown out of the mixing space 35 into the passenger compartment. In other words, the passenger compartment can be dehumidified. The first dehumidification mode can exercise a function of dehumidifying the blown air, but has a limited heating capability.

The refrigerant flowing out of the indoor evaporator 26 flows into the accumulator 29 through the thermosensitive portion 61a of the thermostatic expansion valve 27. A gas-phase refrigerant, which is derived from gas-liquid separation in the accumulator 29, is taken into the compressor 11 and compressed again.

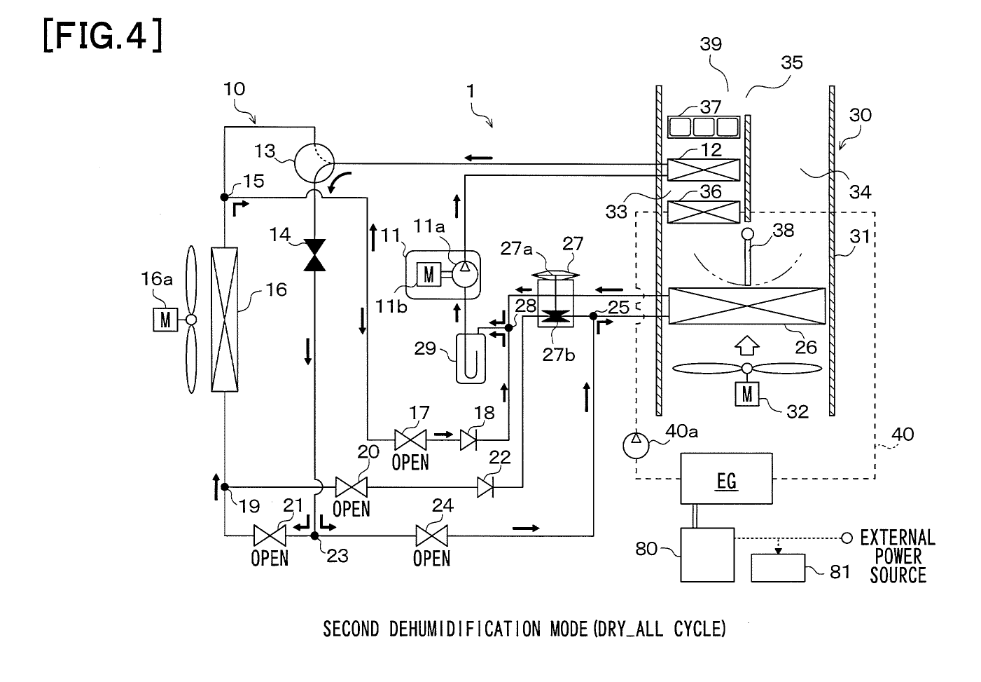

### (d) Second Dehumidification Mode (DRY_ALL Cycle; See FIG. 4)

In the second dehumidification mode, the air-conditioning control device 50 energizes the electric three-way valve 13, the low-voltage solenoid valve 17, and the dehumidification solenoid valve 24, and de-energizes the remaining solenoid valves 20, 21. Therefore, the electric three-way valve 13 connects the refrigerant outlet side of the indoor condenser 12 to the refrigerant inlet side of the fixed throttle 14. Further, the low-voltage solenoid valve 17 opens, the high-voltage solenoid valve 20 opens, the heat exchanger shut-off solenoid valve 21 opens, and the dehumidification solenoid valve 24 opens.

Hence, a vapor compression type refrigeration cycle is formed as indicated by the arrows in FIG. 4 so that the refrigerant sequentially circulates from the compressor 11 through the indoor condenser 12, the electric three-way valve 13, the fixed throttle 14, the third three-way joint 23, the heat exchanger shut-off solenoid valve 21, the second three-way joint 19, the outdoor heat exchanger 16, the first three-way joint 15, the low-voltage solenoid valve 17, the first check valve 18, the fifth three-way joint 28, and the accumulator 29 to the compressor 11, and that the refrigerant also sequentially circulates from the compressor 11 through the indoor condenser 12, the electric three-way valve 13, the fixed throttle 14, the third three-way joint 23, the dehumidification solenoid valve 24, the fourth three-way joint 25, the indoor evaporator 26, the thermosensitive portion 27a of the thermostatic expansion valve 27, the fifth three-way joint 28, and the accumulator 29 to the compressor 11.

In other words, in the second dehumidification mode, the refrigerant flowing from the fixed throttle 14 to the third three-way joint 23 flows toward the heat exchanger shut-off solenoid valve 21 and toward the dehumidification solenoid valve 24. Further, the refrigerant flowing from the first check valve 18 to the fifth three-way joint 28 and the refrigerant flowing from the thermosensitive portion 27a of the thermostatic expansion valve 27 to the fifth three-way joint 28 converge at the fifth three-way joint 28 and flow toward the accumulator 29.

In the above-described refrigerant circuit in the second dehumidification mode, the refrigerant flowing from the outdoor heat exchanger 16 to the first three-way joint 15 does not flow toward the electric three-way valve 13 because the electric three-way valve 13 is connected between the refrigerant outlet side of the indoor condenser 12 and the refrigerant inlet side of the fixed throttle 14. Further, the refrigerant flowing from the dehumidification solenoid valve 24 to the fourth three-way joint 25 does not flow toward the variable throttle mechanism portion 27b of the thermostatic expansion valve 27 because of an action performed by the second check valve 22.

Consequently, the refrigerant compressed by the compressor 11 is cooled in the indoor condenser 12 by heat exchange with the blown air (cool air) after passing through the indoor evaporator 26. This ensures that the blown air passing through the indoor condenser 12 is heated. The refrigerant flowing out of the indoor condenser 12 is decompressed by the fixed throttle 14. The decompressed refrigerant then branches at the third three-way joint 23 and flows into the outdoor heat exchanger 16 and into the indoor evaporator 26.

The refrigerant flowing into the outdoor heat exchanger 16 evaporates as it absorbs heat from the outer air that is blown from the outside of the passenger compartment by the blower fan 16a. The refrigerant flowing out of the outdoor heat exchanger 16 flows into the fifth three-way joint 28 through the low-voltage solenoid valve 17, the first check valve 18, and the like. The low-pressure refrigerant flowing into the indoor evaporator 26 evaporates as it absorbs heat from the air blown from the blower 32. This ensures that the blown air passing through the indoor evaporator 26 is cooled and dehumidified.

Consequently, the blown air cooled and dehumidified by the indoor evaporator 26 is heated again when it passes through the heater core 36, the indoor condenser 12, and the heater core 36, and is blown out of the mixing space 35 into the passenger compartment. In this instance, the second dehumidification mode differs from the first dehumidification mode in that the former enables the indoor condenser 12 to release the heat absorbed by the outdoor heat exchanger 16. Therefore, the second dehumidification mode can heat the blown air to a higher temperature than the first dehumidification mode. In other words, the second dehumidification mode can provide dehumidification and heating at a time, that is, deliver a dehumidification capability while delivering a high heating capability.

Further, the refrigerant flowing out of the indoor evaporator 26 flows into the fifth three-way joint 28, joins with the refrigerant flowing out of the outdoor heat exchanger 16, and flows into the accumulator 29. A gas-phase refrigerant, which is derived from gas-liquid separation in the accumulator 29, is taken into the compressor 11 and compressed again.

Furthermore, as described above, each of the refrigerant circuit in the cooling mode, the refrigerant circuit in the heating mode, and the refrigerant circuit in the first dehumidification mode may be expressed as a refrigerant circuit in a single heat exchanger mode in which the refrigerant taken into the compressor 11 is distributed to either the outdoor heat exchanger 16 or the indoor heat exchanger (or more specifically, the indoor condenser 12 and the indoor evaporator 26). On the other hand, the refrigerant circuit in the second dehumidification mode may be expressed as a refrigerant circuit in a complex heat exchanger mode in which the refrigerant taken into the compressor 11 is distributed to both the outdoor heat exchanger 16 and the indoor heat exchanger (or more specifically, the indoor evaporator 26).

As the air conditioner for a vehicle according to the present embodiment operates as described above, it provides the following advantages.

First, as is described in connection with control step S7 (more specifically, step S704), the blower 32 starts operating at a lower engine cooling water temperature Tw as the number of energized units of the PTC heater 37 increases.

Therefore, the PTC heater 37 can heat the blown air even if lowness of the engine cooling water temperature Tw causes insufficient heating of the blown air at the heater core 36. Therefore, it is possible to early blow out the blown air that is heated by the PTC heater 37 to the occupant without waiting for increase of the engine cooling water temperature Tw. It is hence possible to improve quickness in passenger-compartment air-conditioning (heating).

In addition, it is possible to blow out the blown air which is sufficiently heated by the PTC heater 37 to the occupant even if the engine cooling water temperature Tw is low. Therefore, it is possible to reduce frequency of engine operation that is intended for passenger-compartment air-conditioning (heating) and accordingly to save fuel consumption.

There may be a problem as follows. If the availability factor of the blower 32 increases too much, in other words, if the amount of air flow from the blower 32 increases too much, heat quantity which is lost from the engine cooling water in the heater core 36 increases and so does energy which is necessary to increase the engine cooling water.

In the present embodiment, as a measure to this problem, when the temperature becomes equal to or larger than the first reference temperature T1, the degree of increase in the availability factor of the blower 32 with respect to increase in the availability factor of the PTC heater 37 becomes smaller than when the engine cooling water temperature Tw is lower than the first reference temperature T1. With this operation, it is possible to prevent the amount of air flow from the blower 32 from increasing too much by limiting the availability factor of the blower 32 when the engine cooling water temperature Tw is high. Therefore, it is possible to reduce increase of heat quantity which is lost from the engine cooling water and the energy which is necessary to increase the engine cooling water. It is hence possible to reduce energy consumption of the air conditioning. This is very advantageous in practical use of a hybrid vehicle because it is possible to decrease it is possible to reduce frequency of engine operation that is intended for the air-conditioning (heating) and accordingly to save fuel consumption.

Furthermore, the air conditioner in the present embodiment exhibits the following prominent advantage.

First, as is described in connection with control step S706, the limitation on the availability factor of the blower 32 is relaxed when the air outlet mode is bi-level mode. Therefore, it is possible to increase the amount of the air flow blown out from the face air outlet even if the temperature of the cooling water that flows through the heater core 36 is not sufficiently high. As a result, it is possible to improve comfort of the occupant when solar radiation is strong.

Next, as is described in connection with control step S706, when the engine cooling water temperature is smaller than a certain preset temperature (the first reference temperature T1 or the fifth reference temperature T5 in this example), the limitation on the availability factor of the blower 32 is not relaxed even if the air outlet mode is the bi-level mode. Therefore, it is possible to prevent the amount of the air flow blown out from the foot air outlet from increasing and to accordingly ease the occupant's feeling that his/her feet is receiving cold wind when the blown air temperature is very low.

Next, as is described in connection with control steps S704 and S706, the certain preset temperature (the first reference temperature T1 or the fifth reference temperature T5 in this example) is smaller when the PTC heater 37 is operating than when the PTC heater 37 is not operating. Therefore, it is possible to relax the limitation on the availability factor of the blower 32 when the PTC heater 37 is operating even if the engine cooling water temperature is low. In addition, when the PTC heater 37 is operating, it is possible to increase the blown air temperature even if the engine cooling water temperature is low. Therefore, the occupant's feeling that his/her feet are receiving cold wind is eased. As a result, it is possible to improve, when solar radiation is strong, comfort of the occupant without harming the occupant's feeling that he/she is in a warmed room.

Next, as is described in connection with control step S92, in accordance with increase of the amount of insolation, it becomes more unlikely that the air outlet mode is determined to be the bi-level mode, and it becomes more likely that the air outlet mode is determined to be the face mode. Therefore, it is possible to improve comfort of the occupant by increasing the amount of the air flow blown out from the face air outlet when solar radiation is strong.

In addition, since the proportion of the amount of the air flow blown out from the foot air outlet is smaller in the face mode than in the bi-level mode, it is possible to ease the occupant's feeling that his/her feet is receiving cold wind if it becomes more likely that the air outlet mode is determined to be the face mode.

### Second Embodiment

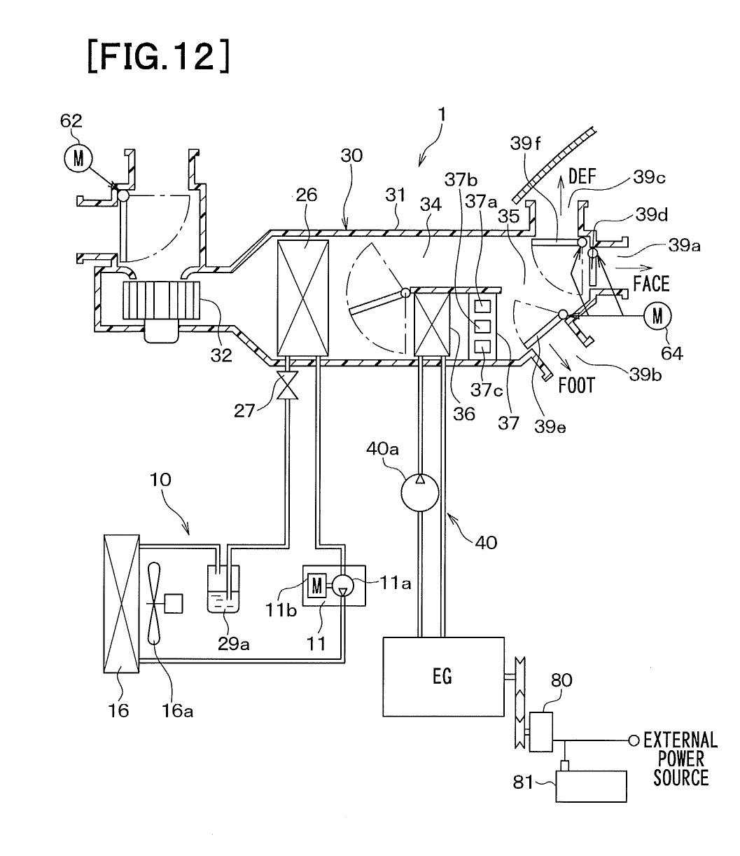

The refrigeration cycle 10 employed in the foregoing embodiment is configured so that the refrigerant circuits for the cooling mode, the heating mode, the first dehumidification mode, and the second dehumidification mode can be selectively used. However, the refrigeration cycle 10 used in the present embodiment of the present invention does not have a function for selecting various refrigerant circuits, as shown in FIG. 12.

More specifically, the refrigeration cycle 10 according to the present embodiment is formed by circularly connecting the compressor 11, the outdoor heat exchanger 16, the thermostatic expansion valve 27, and the indoor evaporator 26 in the order named. The refrigeration cycle 10 according to the present embodiment functions to cool the air to be blown into the passenger compartment from the blower. In other words, the refrigeration cycle 10 according to the present embodiment is configured to be capable of providing the cooling mode of the foregoing embodiment.

Accordingly, the refrigeration cycle 10 according to the present embodiment does not include the solenoid valves 13-24 that act as the refrigerant circuit selection means. Further, the refrigeration cycle 10 according to the present embodiment does not include the accumulator 29 that is connected to the refrigerant inlet of the compressor 11. Instead, the refrigeration cycle 10 according to the present embodiment includes a receiver 29a that acts as a high-pressure side gas-liquid separator that receives the refrigerant from the outdoor heat exchanger 16, separates the received refrigerant into a gas and a liquid, and stores an excess refrigerant. The other elements are the same as those of the first embodiment.

In FIG. 12, the face air outlet 39a, the foot air outlet 39b, the defroster air outlet 39c, the face door 39d, the foot door 39e, and the defroster door 39f are illustrated which are not illustrated in FIGS. 1 to 4.

The operation of the present embodiment is basically performed in accordance with the flowchart of FIG. 7, which depicts the first embodiment. However, as the present embodiment does not include the solenoid valves 13-24 that act as the refrigerant circuit selection means, steps, for example, S6 and S13, which are performed to exercise control concerning refrigerant circuit selection, are not exercised in the present embodiment. Further, step, for example, step S112 of FIG. 10, which depicts the first embodiment and is performed to exercise control concerning an operation mode other than the cooling mode, is not exercised in the present embodiment.

Furthermore, for example, control step S113 of FIG. 10, which depicts the first embodiment and is performed to determine whether the selected operation mode is the cooling mode, is not performed in the present embodiment. More specifically, control step S113 of FIG. 10, for example, need not be performed. Alternatively, step S113 may be performed to constantly determine that the selected operation mode is the cooling mode.

Consequently, even when the control aspect described in conjunction with the foregoing embodiments is applied to the air conditioner for a vehicle 1 according to the present embodiment whose refrigeration cycle 10 is specially configured to provide the cooling mode for cooling the air to be blown into the passenger compartment from the blower, the present embodiment provides the same advantages as the foregoing embodiment.

### Other Embodiments

The present invention is not limited to the above-described embodiments. Various modifications may be made as described below without departure from the spirit of the invention.

(1) In the first embodiment, it is described that the third tentative blower level f(TW) is set to the maximum value (30 level in this example) when the air outlet mode is the bi-level mode and the second tentative blower level f(TW)d is other than the minimum value (other than 0 level in this example), and that the effect of the limitation on the availability factor of the blower 32 is accordingly cancelled. Alternatively, however, the third tentative blower level f(TW) may be set to a value that is smaller than the maximum value and larger than the first tentative blower level f(TAO) so as to relax the limitation on the availability factor of the blower 32.

(2) The first embodiment uses the refrigeration cycle 10 that changes the refrigerant circuit as needed to heat or cool the blown air to be supplied to the passenger compartment. The second embodiment uses the refrigeration cycle 10 that cools the blown air. Obviously, an alternative is to employ a heat pump cycle that heats the blown air by using a radiator for dissipating the heat of the refrigerant discharged from the compressor 11 as an indoor heat exchanger and by using an evaporator for evaporating the refrigerant as an outdoor heat exchanger.

(3) As regards the first to third embodiments, the driving force for running the plug-in hybrid vehicle has not been described in detail. However, the air conditioner for a vehicle 1 is applicable to both a parallel hybrid vehicle and a serial hybrid vehicle. The parallel hybrid vehicle can run by directly acquiring the driving force from both the engine EG and the driving electric motor. The serial hybrid vehicle uses the engine EG as a driving source for the generator 80, stores the generated electrical power in the battery 81, supplies the electrical power stored in the battery 81 to the driving electric motor, and runs by acquiring the driving force from the driving electric motor.

The air conditioner for a vehicle 1 can also be applied to an electric vehicle that does not include the engine EG and acquires the vehicle driving force from only the driving electric motor.

### LIST OF REFERENCE SIGNS

32 . . . Blower
36 . . . Heater core (heating heat exchanger)
50 . . . Control means
37 . . . PTC heater (auxiliary heating means)
39a . . . Face air outlet
39b . . . Foot air outlet
39d . . . Face door (air outlet mode switching means)
39e . . . Foot door (air outlet mode switching means)

1. An air conditioner for a vehicle, comprising:
a blower that generates blown air;
a heating heat exchanger that heats the blown air by heat exchange between the blown air and a heat medium;
a control device that determines the availability factor of the blower; and
an air outlet mode switching device that switches between a plurality of air outlet modes by switching proportions of air flow blown out from a plurality of outlets which includes a face air outlet that blows out the blown air to an upper body of an occupant and a foot air outlet that blows out the blown air to a lower body of an occupant, wherein
the control device:
limits the availability factor of the blower based on a temperature of the heat medium; and
relaxes limitation on the availability factor of the blower when the air outlet mode is a bi-level mode in which the blown air is blown out from both of the face air outlet and the foot air outlet.

2. The air conditioner for the vehicle according to claim 1, wherein the control device:
determines the availability factor of the blower based on an air-conditioning load;
determines an upper limit of the availability factor based on the temperature of the heat medium;
limits the availability factor of the blower so that the availability factor of the blower is equal to or smaller than the upper limit when the air outlet mode is a mode in which the blown air is blown out at least from the foot air outlet; and
determines the upper limit to be equal to or larger than the availability factor of the blower that is determined based on the air-conditioning load when the air outlet mode is the bi-level mode.

3. The air conditioner for the vehicle according to claim 1, wherein the control device does not relax the limitation on the availability factor of the blower when the engine cooling water temperature is smaller than a certain temperature even if the air outlet mode is the bi-level mode.

4. The air conditioner for the vehicle according to claim 3,
comprising:
an auxiliary heating device that heats the blown air,
wherein the control device sets the certain temperature so that the certain temperature is smaller when the auxiliary heating device is operating than when the auxiliary heating device is not operating.

5. The air conditioner for the vehicle according to claim 1, wherein the control device:
limits the availability factor of the blower based on the temperature of the heat medium when the air outlet mode is the bi-level mode;
when the air outlet mode is a face mode in which the blown air is blown out from the face air outlet, reduces limitation on the availability factor of the blower compared to when in the bi-level mode; and
controls the air outlet mode so that, in accordance with increase of an amount of insolation, it becomes more unlikely that the air outlet mode is determined to be the bi-level mode, and it becomes more likely that the air outlet mode is determined to be the face mode.

6. An air conditioner for a vehicle, comprising:
a blower that generates blown air;
a heating heat exchanger that heats the blown air by heat exchange between the blown air and a heat medium;
an air outlet mode switching device that switches between a plurality of air outlet modes by switching proportions of air flow blown out from a plurality of outlets which includes a face air outlet that blows out the blown air to an upper body of an occupant and a foot air outlet that blows out the blown air to a lower body of an occupant, and
a control device that determines the availability factor of the blower and the air outlet mode, wherein
the control device:
limits the availability factor of the blower based on a temperature of the heat medium when the air outlet mode is a bi-level mode in which the blown air is blown out from both of the face air outlet and the foot air outlet;
when the air outlet mode is a face mode in which the blown air is blown out from the face air outlet, reduces limitation on the availability factor of the blower compared to when in the bi-level mode; and
controls the air outlet mode so that, in accordance with increase of an amount of insolation, it becomes more unlikely that the air outlet mode is determined to be the bi-level mode, and it becomes more likely that the air outlet mode is determined to be the face mode.

7. The air conditioner for the vehicle according to claim 6, wherein the control device:
determines the availability factor of the blower based on an air-conditioning load; and
in accordance with increase of the amount of the insolation, narrows down a range of the air-conditioning load in which the air outlet mode is determined to be the bi-level mode is narrowed, and widens a range of the air-conditioning load in which the air outlet mode is determined to be the face mode.
